(19) United States
(12) Patent Application Publication
(10) Pub. No.: US 2025/0175895 A1
(43) Pub. Date: May 29, 2025

(54) NETWORK ASSISTED CELL SELECTION FOR A DEVICE

(71) Applicant: QUALCOMM Incorporated, San Diego, CA (US)

(72) Inventors: Luanxia Yang, Beijing (CN); Xiaojie Wang, Hillsborough, NJ (US); Piyush Gupta, Bridgewater, NJ (US); Junyi Li, Greentown, PA (US)

(21) Appl. No.: 18/844,246

(22) PCT Filed: May 20, 2022
(86) PCT No.: PCT/CN2022/094026

§ 371 Date: Sep. 5, 2024

(51) Int. Cl. H04W 48/20

(52) U.S. Cl. CPC H04W 48/20

(57) ABSTRACT

This disclosure provides systems, methods, and devices for wireless communication that support network-assisted cell selection for a device. In a first aspect, a method of wireless communication includes generating configuration information associated with a cell selection procedure for a user equipment (UE). The cell selection procedure is associated with a passive device or a semi-passive device of the UE. The configuration information includes energy harvesting information, reference signal (RS) configuration information, or a combination thereof. The method further includes transmitting, to the UE, the configuration information. Other aspects and features are also claimed and described.

### TECHNICAL FIELD

Aspects of the present disclosure relate generally to wireless communication systems, and more particularly, to cell selection, such as network-assisted cell selection for a device (e.g., a passive device or semi-passive device). Some features may enable and provide improved communications, including reduced power consumption by the device, reduced overhead signaling, reduced interference, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

A passive device, such as a Radio Frequency identification (RFID) device or an RFID tag, may be used in a variety of environments or areas, such as an inventory/asset management inside and outside of a warehouse, an Internet-of-Things (IoT) system, a sustainable sensor network in a factory and/or agriculture, or a smart home, as illustrative, non-limiting examples. A passive device is configured to emit an information-bearing signal based on receiving a signal. For example, an RFID device may be operated without a battery at a low operating expense (OPEX), a low maintenance cost, and a long-life circle. To further illustrate, the RFID device may be configured to harvest energy over the air and power transmission/reception circuitry where a transmitted signal is typically backscatter modulated. In some implementations, a passive device may be a semi-passive device, such as an active RFID device, which includes a battery.

If a passive device is within a coverage area of a single base station (or a single cell), the passive device may communicate with the single base station. However, if the passive device is within the coverage of multiple base stations (e.g., multiple cells), a passive device may select which base station should be used by the passive device. As passive devices become more prevalent and commonplace, and are deployed in 5G or future networks and/or dense networks having multiple cells, selection of a base station of multiple base stations becomes more complex and can contribute to additional overhead signaling and interference.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a base station includes generating configuration information associated with a cell selection procedure for a user equipment (UE). The cell selection procedure is associated with a passive device or a semi-passive device of the UE. The configuration information includes energy harvesting information, reference signal (RS) configuration information, or a combination thereof. The method further includes transmitting, to the UE, the configuration information.

In an additional aspect of the disclosure, an apparatus includes at least one processor and a memory coupled to the at least one processor. The at least one processor is configured to generate configuration information associated with a cell selection procedure for a UE. The cell selection procedure is associated with a passive device or a semi-passive device of the UE. The configuration information includes energy harvesting information, RS configuration information, or a combination thereof. The at least one processor is further configured to initiate transmission of the configuration information to the UE.

In an additional aspect of the disclosure, an apparatus includes processing system and a communication interface coupled to the processing system. The processing system is configured to generate configuration information associated with a cell selection procedure for a UE. The cell selection procedure is associated with a passive device or a semi-passive device of the UE. The configuration information includes energy harvesting information, RS configuration information, or a combination thereof. The communication interface is configured to transmit, to the UE, the configuration information.

In an additional aspect of the disclosure, an apparatus includes means for generating configuration information associated with a cell selection procedure for a UE. The cell selection procedure is associated with a passive device or a semi-passive device of the UE. The configuration information includes energy harvesting information, RS configuration information, or a combination thereof. The apparatus also includes means for transmitting, to the UE, the configuration information

In an additional aspect of the disclosure, a non-transitory computer-readable medium stores instructions that, when executed by a processor, cause the processor to perform operations. The operations include generating configuration information associated with a cell selection procedure for a UE. The cell selection procedure is associated with a passive device or a semi-passive device of the UE. The configuration information includes energy harvesting information, RS configuration information, or a combination thereof. The operations further include initiating transmission of the configuration information to the UE.

In an additional aspect of the disclosure, a method for wireless communication performed by a UE includes receiving, from a first base station, first configuration information associated with a cell selection procedure. The cell selection procedure is associated with a passive device or a semi-passive device. The first configuration information includes first energy harvesting information, first RS configuration information, or a combination thereof. The method also includes performing the cell selection procedure based on the first configuration information.

In an additional aspect of the disclosure, an apparatus includes at least one processor and a memory coupled to the at least one processor. The at least one processor is configured to receive, from a first base station, first configuration information associated with a cell selection procedure. The cell selection procedure is associated with a passive device or a semi-passive device. The first configuration information includes first energy harvesting information, first RS configuration information, or a combination thereof. The at least one processor is further configured to perform the cell selection procedure based on the first configuration information.

In an additional aspect of the disclosure, an apparatus includes processing system and a communication interface coupled to the processing system. The communication interface is configured to receive, from a first base station, first configuration information associated with a cell selection procedure. The cell selection procedure is associated with a passive device or a semi-passive device. The first configuration information includes first energy harvesting information, first RS configuration information, or a combination thereof. The processing system is configure to perform the cell selection procedure based on the first configuration information.

In an additional aspect of the disclosure, an apparatus includes means for receiving, from a first base station, first configuration information associated with a cell selection procedure. The cell selection procedure is associated with a passive device or a semi-passive device. The first configuration information includes first energy harvesting information, first RS configuration information, or a combination thereof. The apparatus further includes means for performing the cell selection procedure based on the first configuration information.

In an additional aspect of the disclosure, a non-transitory computer-readable medium stores instructions that, when executed by a processor, cause the processor to perform operations. The operations include receiving, from a first base station, first configuration information associated with a cell selection procedure. The cell selection procedure is associated with a passive device or a semi-passive device. The first configuration information includes first energy harvesting information, first RS configuration information, or a combination thereof. The operations further include performing the cell selection procedure based on the first configuration information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports network-assisted cell selection for a device according to one or more aspects.

FIG. 5 is a ladder diagram of an example of network-assisted cell selection for a device according to one or more aspects.

FIG. 6 is a ladder diagram of another example of network-assisted cell selection for a device according to one or more aspects.

FIG. 7 is a ladder diagram of another example of network-assisted cell selection for a device according to one or more aspects.

FIG. 8 is a flow diagram illustrating an example process that supports network-assisted cell selection for a device according to one or more aspects.

FIG. 9 is a block diagram of an example UE that supports network-assisted cell selection for a device according to one or more aspects.

FIG. 10 is a flow diagram illustrating an example process that supports network-assisted cell selection for a device according to one or more aspects.

FIG. 11 is a block diagram of an example base station that supports network-assisted cell selection for a device according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The electromagnetic spectrum is often subdivided, based on frequency (or wavelength), into various classes, bands or channels. In fifth generation (5G) new radio (NR), two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band (or spectrum) in documents and articles, despite being different than the extremely high frequency (EHF) band (30 GHz-300 GHz) which is identified by the International Telecommunications Union (ITU) as a “millimeter wave” band. With the above aspects in mind, unless specifically stated otherwise, it should be understood that the term “sub-6 GHz” or the like if used herein may broadly represent frequencies that may be less than 6 GHz, may be within FRI, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

The present disclosure provides systems, apparatus, methods, and computer-readable media that support network-assisted cell selection for a device. For example, a network entity may assist a device to select a cell or base station to serve the device. In some implementations, the network entity may include a base station, a core network, or a central unit (CU), and the device may include a user equipment (UE), a passive or semi-passive device, such as a radio-frequency identification (RFID) device or tag, or a combination thereof. The device may be configured to perform a cell selection procedure to select a cell or base station to serve the device. In some implementations, the cell selection procedure may include the device receiving configuration information associated with the cell selection procedure, receiving one or more reference signals (RSs), generating or transmitting one or more backscatter signals or waveforms based on the one or more reference RSs, receiving one or more cell serve indications, selecting a cell or a base station based on the one or more cell serve indications (indicating that a base station is available or willing to serve the device), generating or transmitting a cell serve request (indicating that the device request to be served by a cell or base station), or a combination thereof.

To assist the device in association with the cell selection procedure, the network entity may be configured to generate or transmit the configuration information which includes energy harvesting information (which indicates whether or not the network entity supports energy harvesting), an RS configuration information (which indicates a periodicity of a cell selection reference signal, a number of backscatter reference signals, a time window parameter (of a response monitoring time window, an RS occasion, or both), or a combination thereof), or a combination thereof. In some implementations, the configuration information includes the energy harvesting information and the RS configuration information. The network device may be configured to periodically transmit the configuration or to include the configuration information in another transmission, such as a transmission that includes one or more RSs or a transmission that includes a cell serve indication. Additionally, or alternatively, to assist the device in association with the cell selection procedure, the network entity may be configured provide a cell serve indication based on a quality of a backscatter waveform received from the device. In some implementations, the quality of the backscatter waveform may be associated with an error rate, a reference signal received power (RSRP), a received signal strength indicator (RSSI), a reference signal received quality (RSRQ), a number of backscatter reference signals associated with the backscatter waveform, or a combination thereof.

Additionally, the network entity may be configured to provide the assistance in coordination with one or more other network entities or without coordination with the one or more other network entities. If assistance is provided without coordination, the device may receive cell serve indications from multiple network entities. In such situations, the device may select a cell or base station randomly, based on an order in which the cell serve indications are received, base on a signal quality of a transmission received from a cell or base station, or a combination thereof. If assistance is provided without coordination, the network entity may determine a characteristic (e.g., a quality) of one or more transmission received from the device. The network entity may transmit or receive a report from another network entity, such as a base station, a core network, or a CU, that indicates the characteristic of one or more transmissions from a device, an ID of the device, a physical cell ID (PCI) associated with the network entity, a load associated with the network entity, or a combination thereof. Based on the exchange of one or more reports amongst multiple network entities of a network, the network may determine one or more monitoring time windows for one or more devices of the network, assign the one or more devices to different network entities, determine pre-coding or beam-configurations for the one or more devices, or a combination thereof.

Particular implementations of the subject matter described in this disclosure may be implemented to realize one or more of the following potential advantages or benefits. In some aspects, the present disclosure provides techniques for network-assisted cell selection for a device. The network-assisted cell selection may enable improved communications, including reduced power consumption by the device, reduced overhead signaling, reduced interference, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

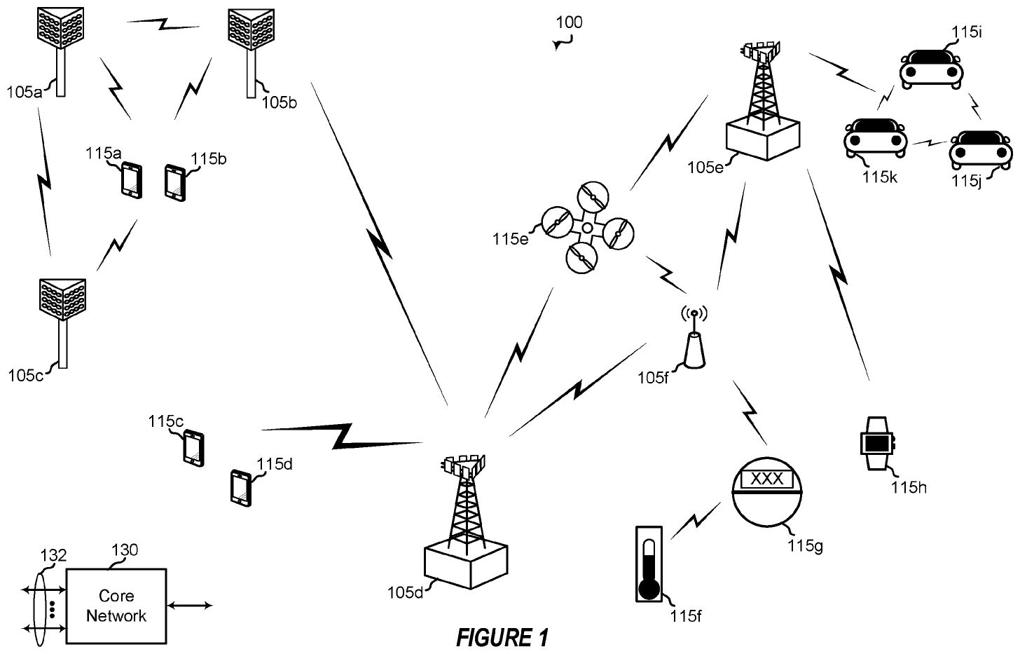

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

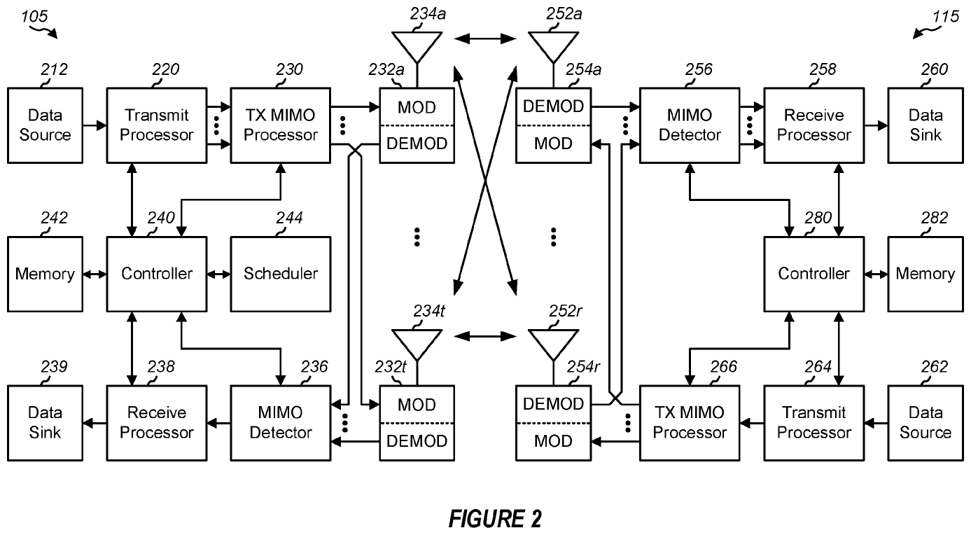

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

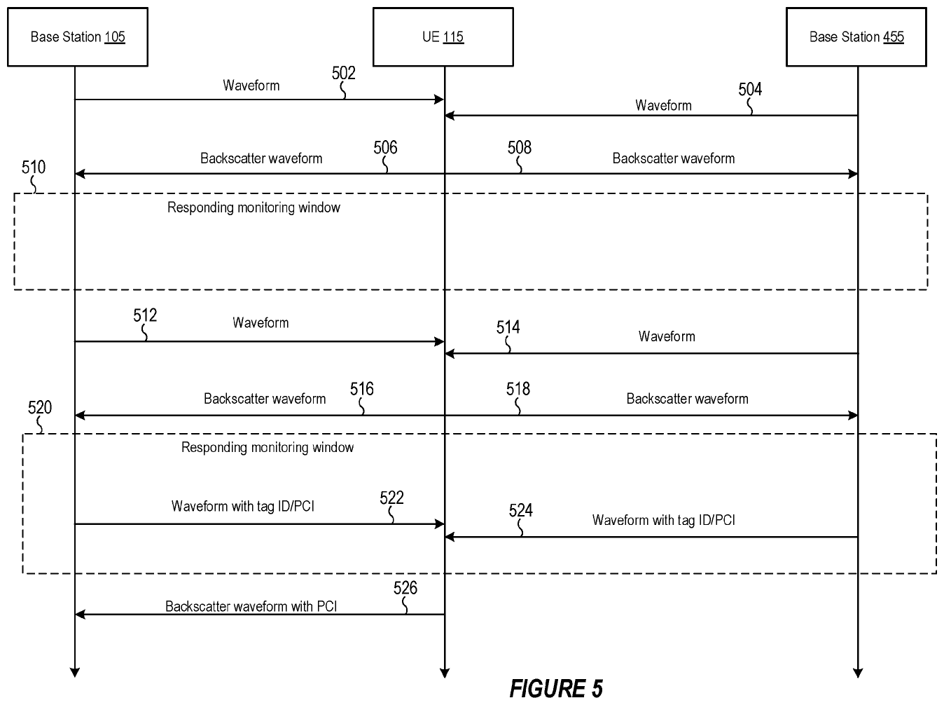

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in at least FIGS. 5-8 or 10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

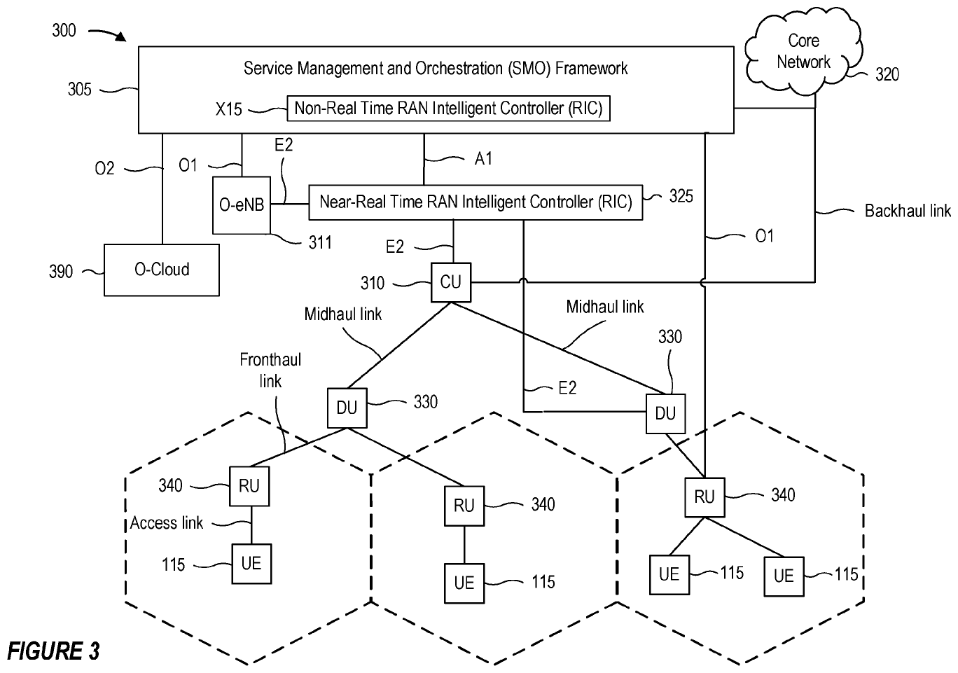

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

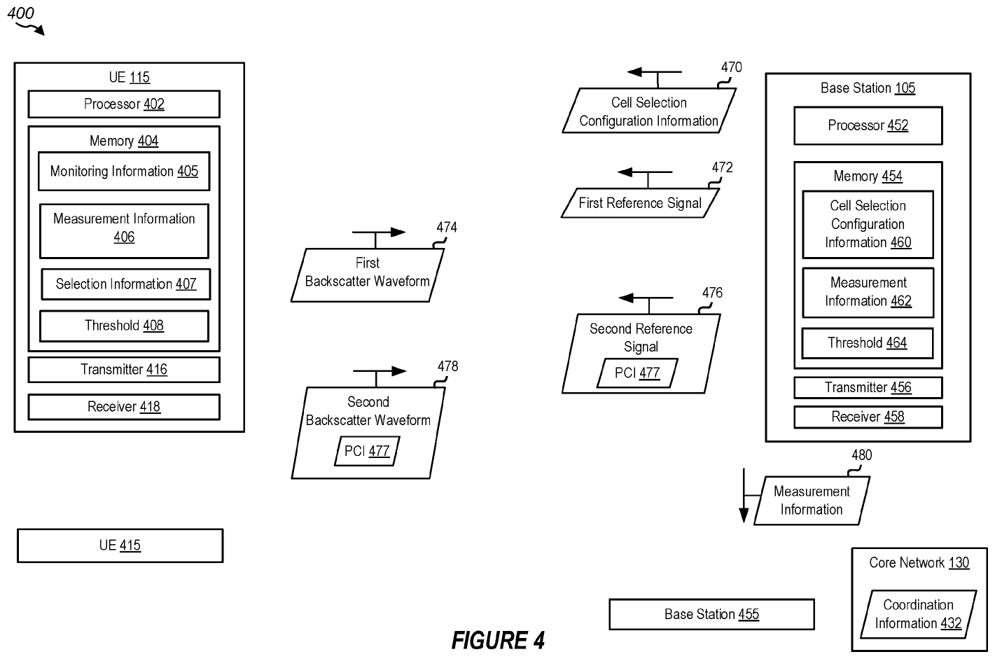

FIG. 4 is a block diagram of an example wireless communications system 400 that supports network-assisted cell selection for a device according to one or more aspects. In some examples, wireless communications system 400 may implement aspects of wireless network 100. Wireless communications system 400 includes UE 115, a UE 415, base station 105, a base station 455, and core network 130. Although two UEs 115 and two base stations 105 are illustrated, in some other implementations, wireless communications system 400 may generally include one or more than two UE 115, one or more than two base stations, or a combination there of. In some implementations a single base station may be associated with or provide one or more cells or one or more coverage areas.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions stored in memory 404 to perform the operations described herein. In some implementations, processor 402 includes or corresponds to one or more of receive processor 258, transmit processor 264, and controller 280, and memory 404 includes or corresponds to memory 282. In some implementations, UE 115 is a 5G-capable UE, a 5G-capable passive device, a 5G-capable semi-passive device, a 5G-capable RFID device, a 5G-capable RFID tag, or a combination thereof.

Memory 404 includes or is configured to store monitoring information 405, measurement information 406, selection information 407, and one or more thresholds 408 (hereinafter referred to collectively as “threshold 408”). Monitoring information 405 may include or indicate one or more time periods or time windows during which UE 115 is configured to monitor for a signal or waveform. Additionally, or alternatively, monitoring information may include a coding/decoding scheme, a beam configuration, a repetition, or a combination thereof. Measurement information 406 may include or indicate information associated with one or more received signals or waveforms. To illustrate, for a received signal or waveform, measurement information 406 may include or indicate an error rate, a reference signal received power (RSRP), a received signal strength indicator (RSSI), a reference signal received quality (RSRQ), or a combination thereof. Selection information 407 may include or indicate one or more criteria for UE 115 to select a cell. For example, the selection information 407 may include or indicate whether a base station associated with the cell should support energy harvesting, such as always or partially. Threshold 408 may include or indicate one or more thresholds. For example, threshold 408 may be used in a comparison, such as a comparison that includes or is based on measurement information 406.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

UE 415 may include one or more components as described herein with reference to UE 115. In some implementations, UE 415 is a 5G-capable UE, a 5G-capable passive device, a 5G-capable semi-passive device, a 5G-capable RFID device, a 5G-capable RFID tag, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store cell selection configuration information 460, measurement information 462, and one or more thresholds 408 (hereinafter referred to collectively as “threshold 464”). Cell selection configuration information 460 may include or indicate monitoring information 405, selection information 407, energy harvesting information, reference signal (RS) configuration information, a mode, a pre-coding scheme, a beam configuration, a repetition, or a combination thereof. The energy harvesting information indicates whether base station 105 supports energy harvesting, such as always, temporarily, or never. The RS configuration information includes or indicates a periodicity of a cell selection reference signal, a number of backscatter reference signals, a time window parameter (e.g., monitoring information 405), or a combination thereof. The mode may be associated with a joint coherent transmission (JCT) mode, a non-coherent joint transmission (NCJT), or a dynamic point selection (DPS) mode. Additionally, or alternatively, the mode may indicate whether base station 105 is configured to perform cell selection assist operations in coordination with one or more other base stations or the network (e.g., core network 130 or a CU 310) or uncoordinated with the one or more other base stations or the network (e.g., core network 130 or a CU 310). Measurement information 462 may include or indicate information associated with one or more received signals or waveforms. To illustrate, for a received signal or waveform, measurement information 462 may include or indicate an error rate, an RSRP, an RSSI, an RSRQ, or a combination thereof. Threshold 464 may include or indicate one or more thresholds. For example, threshold 464 may be used in a comparison, such as a comparison that includes or is based on measurement information 462.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 358 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Base station 455 may include one or more components as described herein with reference to base station 105. In some implementations, base station 455 is a 5G-capable base station.

Core network 130 may include a 4G core network, a 5G core, an evolved packet core (EPC). Core network may be coupled, such as communicatively coupled, to UE 115, UE 415, base station 105, base station 455, or a combination thereof.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP.

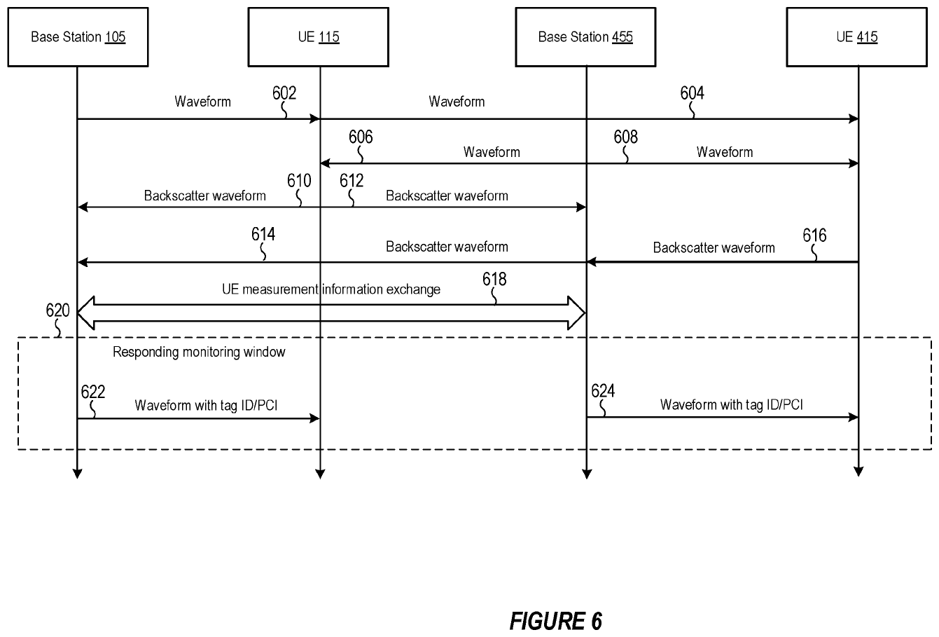

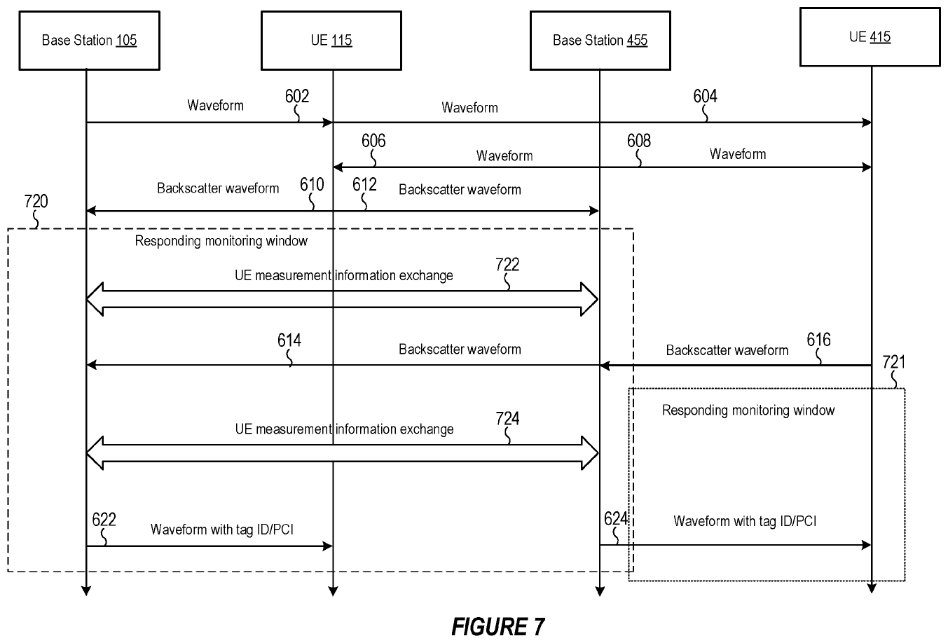

In some implementations, UE 115 or UE 415 is a passive device that is under the coverage of one or more cells and wants to access the network. For example, UE 115 may be under coverage of multiple cells, such as a first cell associated with base station 105 and a second cell associated with base station 455. UE 115 or UE 415 can select a cell based a cell selection procedure. In some implementations, the cell selection procedure may include the device receiving configuration information associated with the cell selection procedure, receiving one or more reference signals (RSs), generating or transmitting one or more backscatter signals or waveforms based on the one or more reference RSs, receiving one or more cell serve indications, selecting a cell or a base station based on the one or more cell serve indications (indicating that a base station is available or willing to serve the device), generating or transmitting a cell serve request (indicating that the device request to be served by a cell or base station), or a combination thereof. To reduce power consumption of UE 115, base station 105, base station 455, or both may assist UE 115 to select a cell. For example, base station 105 may assist UE 115 without coordination of one or more other base stations, as described further herein at least with reference to FIG. 5, or with coordination of one or more other base stations, as described herein at least with reference to FIGS. 6-7.

In some implementations, base station 105 or base station 455 may provide information associated with cell selection by UE 115 or UE 415. For example, base station 105 may provide cell selection configuration information 460 to assist UE 115 to select a cell. In some implementations, cell selection configuration information 460 may enable base station 105 to trigger cell selection by UE 115 or enable UE 115 to provide one or more signals or waveforms to enable base station 105 to assist with cell selection.

In some implementations, a base station may transmit cell selection configuration information 470 base on cell selection configuration information 460. For example, base station 105 may periodically transmit cell selection configuration information 460. As another example, base station 105 may transmit cell selection configuration information 460 non-periodically. Additionally, or alternatively, base station 105 may be configured to include the cell selection configuration information 460 or 470 in another transmission, such as a transmission that includes one or more RSs or a transmission that includes a cell serve indication, as described further herein.

Reception of cell selection configuration information 460 by a UE, such as UE 115, may enable UE 115 to perform a cell selection procedure, such as a cell selection procedure with base station 105. In some implementations, cell selection configuration information 460 or 470 may indicate whether or not a base station supports energy harvesting, such as always, temporarily, or never. Additionally, or alternatively, cell selection configuration information 460 may indicate a RS configuration. The RS configuration may include or indicate a periodicity of a reference signal for cell selection, a number of backscatter RS (e.g., a minimum number of backscatter RS), a time window parameter, or a combination thereof. In some implementations, the periodicity of the reference signal for cell selection may be useful for a semi-passive device to enable the semi-passive device to wake from a low power or idle mode based on the periodicity of the reference signal. In some implementations, the time window parameter may be associated with a responding monitoring window during which a UE monitors for a signal or waveform from a base station that indicates the base station is available or willing to serve the UE. To illustrate, the time window parameter may include or indicate a start point of the time window, an end point of the time window, a duration of the time window, an offset value (e.g., a time difference from the passive device receiving the indication and the passive device starting to monitor), or a combination thereof, as illustrative, non-limiting examples. In some implementations, one or more parameters of the time window may be defined by a standard.

In some implementations, a base station may receive one or more backscatter waveforms from a UE and, based on a detected event, may indicate to the UE that the base station is available or willing to serve the UE. In some implementations, the detected event may include a backscatter waveform having a quality level that satisfies a threshold (e.g., 464), may indicate to the UE that the base station is available or willing to serve the UE, or a combination thereof. For example, if an error rate of the backscatter waveform is less than or equal to a threshold (e.g., 464), the base station may indicate to the UE that the base station is available or willing to serve the UE. As another example, if an RSRP, an RSSI, or an RSRQ of the backscatter waveform is greater than or equal to a threshold (e.g., 464), the base station may indicate to the UE that the base station is available or willing to serve the UE.

In some implementations, one or more base stations, the network, or a combination thereof, may be configured to assist UE cell selection without coordination between the one or more base stations and the network. A base station, such as base station 105, may assist a UE, such as UE 115, with cell selection and enable the UE to reduce power consumption. For example, the base station may receive and measure a backscattered waveform from the UE and decide whether or not to serve the UE based on the measured backscattered waveform. To illustrate, the base station may transmit related information for cell selection independently of related information for cell selection transmitted by one or more other base stations. The related information may include the cell selection configuration information, one or more reference signals, a waveform (e.g., a continuous waveform for a time period), or a combination thereof. If the UE is under the coverage of multiple cells (e.g., multiple base stations), transmission from each of the multiple cells may at least partially overlap and cause interference with each other. The interference may result in the UE not being able to decode the information correctly. In some implementations, a base station may time division multiplex (TDM) or frequency division multiplex (FDM) information to be transmitted to the UE.

Additionally, the UE may be configured to backscatter a received signal or waveform, or a portion of the received signal or waveform. In some implementations, a base station may be configured to transmit a reference signal to a UE. To illustrate, the reference signal may be unicast or broadcast. The reference signal may include a waveform, such as a continuous waveform, that is transmitted during an RS occasion. In some implementations, the reference signal may include a PCI of the base station, cell selection configuration information (e.g., 460), or a combination thereof.

The UE may be configured to perform cell selection and generate a backscatter signal or waveform based on the reference signal and/or the PCI associated with a base station. For example, the UE may generate the backscatter signal or waveform based on at least X RS measurements, where X is a positive integer. The UE may be configured to transmit the backscatter signal or waveform after an RS occasion. For example, after an RS occasion, the UE may begin transmitting the backscatter signal or waveform at a time T₁ after an end of the RS occasion. In some implementations, a start of transmission of the backscatter signal or waveform is to begin within a time period of [T_{1,min}, T_{1,max}] starting after the end of the RS occasion. Additionally, the UE may be configured to end transmission of the backscatter signal or waveform at a time T₂ before a next RS occasion. In some implementations, the time T₂ may be based on a duration of a backscatter time window that begins at T₁, T_{1,min}, or T_{1,max}. In other implementations, transmission of the RS occasions by the base station may be periodic and the time T₂ may be based on (e.g., an offset with respect to) a start of an RS occasion. In some implementations, one or more parameters of the backscatter time window, a periodicity of the RS occasions, or a combination thereof, may be included or indicated by cell selection configuration information 460.

In some implementations, the base station is configured to receive and measure the backscatter signal or waveform (e.g., a backscattered RS). The base station may determine whether or not the base station is available or willing to serve the UE based on one or more measurements of the received backscatter signal or waveform. To illustrate, the base station may configure the UE to backscatter X RS. For example, the base station may configure the UE based on cell selection configuration information 460. The base station may transmit X RS using the same or different beam-forming and/or precoding. For example, the base station may transmit at least X RS during an RS occasion. In some implementations, if the base station transmits the same RS at least X times during the RS occasion, the base station may be configured to measure the received backscattered RSs individually, average a number of measurements of the received backscattered RSs, or a combination thereof. In some implementations, measuring may include determining or calculating an error rate, an RSRP, an RSSI, an RSRQ, or a combination thereof of the backscatter signal or waveform. By measuring the at least X backscatter RS received from the UE, the base station may determine whether or not the base station is available or willing s to serve the UE, a beam-forming or precoding for communication with the UE, or a combination thereof. For example, if a quality of the measured backscatter signal or waveform satisfies a threshold, the base station may transmit a PCI of the base station to the UE. To illustrate, the base station may transmit the PCI of the base station during a time window associated with the UE monitoring period. The time window associated with the UE monitoring period may be configure or defined based on cell selection configuration information 460 (or 470) or a standard. If a quality of the measured backscatter signal or waveform satisfies a threshold, the base station may not transmit the PCI to the UE or may transmit a NACK.

In some implementations, the UE may monitor for a response (e.g., the PCI) from the base station, at a time T₃ after the UE stops transmitting the backscatter signal or waveform or after an end of the backscatter time window. Additionally, the UE may be configured to end monitoring at a time T₄ before a next RS occasion. In some implementations, the time T₄ may be based on a duration of the time window associated with the UE monitoring period that begins at the time T₃. In other implementations, transmission of the RS occasions by the base station may be periodic and the time T₄ may be based on (e.g., an offset with respect to) a start of an RS occasion. If the UE does not receive a response (including the PCI from the base station) during the time window associated with the UE monitoring period, the UE may monitor a next RS occasion.

In some implementations, if a base station is configured to assist a UE without coordination, a UE may be configured by M base stations, where M is a positive integer greater than 2, to backscatter one or more RSs from each of the M base stations. Having to backscatter one or more RSs for each of the M base stations may cause a power or battery issue at the UE. For example, the UE may be able to backscatter a number of RS during a time period, such as Y ms, where Y is a positive number, due to a power limitation, a voltage limitation, a battery limitation, or a combination thereof.

Due to the power, voltage, or battery limitation, the UE may drop some RSs (i.e., not backscatter some selected RSs). In some implementations, the UE may selectively drop one or more RSs based on a UE-side measurement. For example, the UE be configured may drop the one or more RSs that have a poor signal quality, such as a measured value that does not satisfy a threshold (e.g., 408). As another example, the UE may be configured to drop one or more RSs based on a voltage, power, or battery level of the UE. For example, the UE may detect a power level or voltage level of the UE and may drop the one or more RSs based on the detected power level or the detected voltage level failing to satisfy a threshold—e.g., based on the detected power level or the detected voltage level being less than or equal to the threshold. In some implementations, the UE may indicate to the base station, after the UE drops the one or more RSs, that the UE dropped the one or more RSs so that the base station may discard one or more measurements based on a backscatter signal or waveform received from the UE. For example, the UE may transmit a termination indication to the base station that indicates that the UE dropped one or more RSs from being backscattered.

In some implementations, if a base station determines (e.g., based on a backscatter signal or waveform measurement) that the base station is available or willing to serve the UE, the base station may transmit a communication that includes a willing to serve indication, a PCI of the base station, or a combination thereof, to the UE. Based on or in response to the communication, the UE may transmit an ACK, a willing-to-be served indication, the PCI of the base station, or a combination thereof, to indicate that the UE selects the base station.

In some implementations, if a base station is configured to assist a UE without coordination, a UE may receive an indication that a base station is available or willing to serve the UE from multiple base stations. In such situations, the UE may consider UE-side feedback. To illustrate, if multiple willing-to-serve indications are received at the UE, the UE may perform a selection procedure to select a base station to serve the UE. The UE may select the base station randomly, based on a first base station to transmit a willing-to-serve indication, based on one or more UE-side measurements of signals or waveforms received from a base station, or a combination thereof.

In some implementations, if a base station is configured to assist a UE with coordination with one or more other base stations or the network. A base station assisting the UE with cell selection while the base station is configured to coordinate with the one or more other base stations or the network may reduce interference experienced by the UE as compared to the base station assisting the UE in an uncoordinated manner. Additionally, or alternatively, if the base station is configured to assist a UE with coordination with one or more other base stations or the network, situations may be avoided where the UE is served by more than one base station or is not served by any base station. If the base station is configured for coordination, the base station may be configured to receive or measure a backscatter waveform from a UE as described above.

In some implementations, if the base station is configured to assist a UE with coordination with one or more other base stations or the network, the base station may be configured in a mode or scheme, such as a communication mode or a communication scheme. The mode or scheme may include a joint coherent transmission (JCT) mode or scheme, a non-coherent joint transmission (NCJT) mode or scheme, or dynamic point selection (DPS) scheme, as illustrative, non-limiting examples.

In the JCT mode or scheme, one or more base stations serve a UE and signals or waveforms from the one or more base stations arrive at the UE coherently. To illustrate, RSs from different base stations may be transmitted using different pre-coding at different base stations. A pre-coding used by a base station for a UE may be selected, e.g., by the base station, the network, core network 130, or CU 310, based on a backscatter waveform received by the base station from the UE. In the NCJT mode or scheme, the one or more base stations may operate in the same or similar manner as the JCT mode or scheme; however, signals or waveforms from the one or more base stations arrive at the UE incoherently. In some implementations, in the NCJT mode or scheme, the UE may not perform cell selection and each of one or more base stations may be used to serve the UE.

In the DPS mode or scheme, one or more base stations (e.g., a subset) of a plurality of base stations may be selected to serve or attempt to serve a UE. The one or more base stations may be selected such that the one or more base stations have non-overlapping cell areas. Additionally, or alternatively, the one or more base stations (e.g., the subset) may be selected such that different base stations of the subset are select to serve the UE at different times. In some implementations, the DPS mode or scheme may ensure that each of multiple UEs can be served.

In some implementations, a UE may be configured to operate in FR2. if the UE is configured to operate in FR2, such as while one or more base stations are configured in the DPS mode or scheme, the UE may need to configure or tune one or more beams. In such situations, a base station may need to signal or configure a UE and indicate what RSs are so that UE can tune a beam. For example, the UE may perform one or more measurements to tune the beam of the UE.

In some implementations, the JCT mode or scheme, the NCJT mode or scheme, or the DPS mode or scheme may be a multi-transmission and reception point (TRP) framework, e.g., multi-TRP belongs to a same cell. In the TRP framework, a base station may use more than one TRP to communicate with a UE.

In some implementations, if a base station is configured to coordinate with the one or more other base stations or the network, the base station may measure a backscatter waveform from a UE to generate measurement information, such as measurement information 462. The base station may exchange measurement information (e.g., transmit the measurement information of the base station, receive measurement information of another base station, or a combination thereof) with one or more other base stations, the network, core network 130, or CU 310. In some implementations, a base station that receives a backscatter waveform from a UE may exchange measurement information based on the received backscatter waveform, prior to or during a responding monitoring window associated with the UE. Additionally, or alternatively, a base station may exchange measurement information periodically.

In some implementations, the exchange of the measurement information may include an ID of the UE, a PCI of the base station, an indication of one or more measurements, or a combination thereof. Additionally, or alternatively, the base station may exchange the measurement information with another base station, the network, core network 130, or CU 310. The network, core network 130, or CU 310 may be configured to register a UE (e.g., store or track the ID of the UE and an associated service area), instruct a base station which UE serve, or a combination thereof. In some implementations, the network, core network 130, or CU 310 may instruct the base station of which pre-coding, beam-forming, or both to use with the UE. The network, core network 130, or CU 310 may determine the pre-coding, the beam-forming, or both based on measurement information received from one or more base stations, a load of a base station or cell, or a combination thereof.

In some implementations, each UE of one or more UEs may have the same start time for a responding monitoring window associated with the UE. An example of each UE sharing the same start time for a responding monitoring window is described further herein, at least with reference to FIG. 6. In other implementations, each UE of the one or more UEs may have its own start time of a responding window associated with the UE that is independent of, or distinct from, at least one other UE of the one or more UEs. An example of two UEs having different start times is described further herein, at least with reference to FIG. 7.

During operation of wireless communications system 400, base station 105 may generate and transmit cell selection configuration information 470 for UE 115, UE 415 or both. For example, base station 105 may unicast, broadcast, or multicast cell selection configuration information 470. In some implementations, base station 105 may periodically transmit cell selection configuration information. Cell selection configuration information 470 may be generated based on cell selection configuration information 460. Cell selection configuration information 470 may include energy harvesting information, RS configuration information, or a combination thereof. In some implementations, cell selection configuration information 470 includes the energy harvesting information and the RS configuration information. The energy harvesting information may indicate (e.g., be indicative of) whether base station 105 supports energy harvesting. The RS configuration information may include or indicate a periodicity of a cell selection reference signal, a number of backscatter reference signals, a time window parameter, or a combination thereof. Additionally, or alternatively, cell selection configuration information 470 may include or indicate a UE identifier of a UE, a PCI associated with base station 105, a repetition indicator, a beam configuration, coding/decoding information, or a combination thereof. UE 115, UE 415, or both may receive cell selection configuration information 470. UE 115 may store cell selection configuration information 470 as part of monitoring information 405, selection information, or a combination thereof.

Base station 105 may transmit a first reference signal 472. First reference signal 472 may be associated with a cell selection procedure of UE 115. In some implementations, first reference signal includes a continuous waveform. First reference signal 472 may be transmitted prior to or after cell selection configuration information 470. In some implementations, first reference signal 472 includes or indicates cell selection configuration information 470.

UE 115 may receive first reference signal 472 and may generate a first backscatter waveform 474 based on first reference signal 472. In some implementations, UE 115 may determine whether to drop first reference signal 472, or a portion thereof, prior to or as part of generation of the first backscatter waveform 474. For example, UE 115 may determine whether or not to drop first reference signal 472 (or a portion thereof) based on a detected power condition at the UE, a measured characteristic of first reference signal 472, or a combination thereof. In some implementations, UE 115 may store the measured characteristic of first reference signal 472 as part of measurement information 406. In the event that UE 115 determines to drop first reference signal 472 (or a portion thereof), UE 115 may transmit a termination indication to base station 105.

UE 115 may transmit first backscatter waveform 474. For example, UE 115 may transmit first backscatter waveform 474 during a backscatter time window as described herein. In some implementations, first backscatter waveform 474 includes one or more backscattered RSs, the UE ID of UE 115, the PCI of base station 105, or a combination thereof. Additionally, or alternatively, first backscatter waveform 474 may include or be transmitted along with a NACK. For example, UE 115 may determine to not select base station 105 based on cell selection configuration information 470, such as the energy harvesting information, and may transmit the NACK to base station 105. As another example, UE 115 may determine to not select base station 105 based on one or more measured characteristics associated with first reference signal 472.

After transmitting first backscatter waveform 474, UE 115 may monitoring for a second reference signal (e.g., 476) from base station 105 during a monitoring time window, such as a responding monitoring window as described herein.

Base station 105 may receive first backscatter waveform 474 associated with first reference signal 472. Base station may determine backscatter information based on received first backscatter waveform 474. The backscatter information may be associated with a characteristic of first backscatter waveform 474. For example, the characteristic may be a measurement of first backscatter waveform 474, such as an error rate, an RSRP, an RSSI, an RSRQ, a number of backscatter reference signals associated with first backscatter waveform 474, or a combination thereof. In some implementations, base station 105 may store the backscatter information as part of measurement information 462. Additionally, or alternatively, base station 105 may perform a comparison based on a value of the measured characteristic and a threshold (e.g., 464). Base station may generate or transmit a second reference signal 476 based on a result of the comparison.

In some implementations, after receiving first backscatter waveform 474, base station 105 may receive the termination indication from UE 115. Based on the termination indication, base station 105 may discarding information (e.g., backscatter information) associated with first backscatter waveform 474. Additionally, or alternatively, in some implementations, base station 105 may transmit, based on the received first backscatter waveform 474, a second reference signal 746 to UE 115. Second reference signal may include PCI 477 associated with base station 105, a UE ID of UE 115, a cell serve indication, or a combination thereof. The cell serve indication may indicate whether or not base station 105 is available or willing to serve UE 115. In some implementations, when base station 105 is unavailable or unwilling to serve UE 115, second reference signal 476 may include or be transmitted along with a negative-acknowledgment (NACK). In some implementations, second reference signal 476 may be transmitted periodically by base station 105, may include or indicate cell selection configuration information 470, or a combination thereof. After transmission of second reference signal 476, base station may monitor for a second backscatter waveform (e.g., 478) from UE 115.

UE 115 may receive second reference signal 476. UE 115 may determine whether second reference signal 476 includes a cell serve indication that indicate that base station 105 is available or willing to serve UE 115. Based on second reference signal 476, UE 115 may generate a second backscatter waveform 478. Second backscatter waveform 478 may include or indicate PCI 477 of base station 105, a cell service request, or a combination thereof. The cell service request may request that base station 105 serve UE 115. UE 115 may transmit second backscatter waveform 478. To illustrate, UE 115 may unicast, multicast, or broadcast second backscatter waveform 478, as illustrative, non-limiting examples.

Base station 105 may receive second backscatter waveform 478 associated with second reference signal 476. Base station 105 may determine whether second backscatter waveform 478 includes an indication of PCI 477, the cell service request, or a combination thereof. Additionally, or alternatively, base station 105 may measure a characteristic associated with second backscatter waveform 478. The characteristic may include an error rate, an RSRP, an RSSI, an RSRQ, a number of backscatter reference signals associated with second backscatter waveform 478, or a combination thereof. Base station 105 may store information associated with the characteristic as part of measurement information 462.

In some implementations, UE 115 may receive, base station 455, configuration information associated with the cell selection procedure. The configuration information receive from base station 455 may be the same as or different from cell selection configuration information 470 from base station 105. The configuration information receive from base station 455 may include energy harvesting information, RS configuration information, or a combination thereof. UE 115 may performing the cell selection procedure based on the configuration information receive from base station 455.

In some implementations, UE 115 may receive, from base station 455, a third reference signal. UE 115 may generate a third backscatter waveform based on the third reference signal, and transmit the third backscatter waveform. After transmission of the third backscatter waveform, UE 115 may monitor for a fourth reference signal from base station 455 during a monitoring time window.

In some implementations, UE 115 may receive second reference signal 476 including a first cell serve indication associated with base station 105 and may receive the fourth reference signal including a second cell serve indication associated with base station 455. UE 115 may select one of base station 105 or base station 455 to serve UE 115. For example, the one of base station 105 or base station 455 may be selected randomly, based on cell selection configuration information 470, based on cell selection configuration information from base station 455, based on the first received cell serve indication, based on a characteristic of second reference signal 476, based on the second received cell serve indication, based on a characteristic of the fourth reference signal, or a combination thereof.

In some implementations, UE 415 may receive one or signals or waveforms transmitted by base station 105, base station 455, UE 115, or a combination thereof. Additionally, or alternatively, UE 415 may transmit one or more signals or waveforms that are received by UE 115, base station 105, base station 455, or a combination thereof. To illustrate, UE 415 may be configured to perform one or more operations of a cell selection procedure as described with reference to UE 115.

In some implementations, base station 455 may receive one or signals or waveforms transmitted by base station 105, UE 115, UE 415, or a combination thereof. Additionally, or alternatively, base station 455 may transmit one or more signals or waveforms that are received by UE 115, base station 105, UE 415, or a combination thereof. To illustrate, base station 455 may be configured to perform one or more operations to assist a cell selection procedure as described with reference to base station 105. For example, base station 455 may be configured to perform one or more operations to assist a cell selection procedure performed by UE 115, UE 415, or both.

In some implementations, base station 105, base station 455, or both, may transmit a measurement report to a network entity. For example, base station 105 may transmit measurement information 480. Measurement information may include or correspond to measurement information 462. The network entity may include a base station, core network 130, or CU 310. In some implementations, the measurement report (e.g., 480) may include measurement information associated with measured characteristics of one or more backscatter waveforms, a UE ID, a PCI of a transmitting base station, load information of a transmitting base station or cell, or a combination thereof.

In some implementations, base station 105, base station 455, or both, may receive, from the network entity, coordination information 432 indicating one or more UEs to be served, a pre-coding, a beam configuration, a load, or a combination thereof. Additionally, or alternatively, base station 105, base station 455, or both, may receive receiving, from a network entity, a mode indication. The mode indication may be associated with a JCT mode or scheme, an NCJT mode or scheme, or a DPS mode or scheme. In some implementations, coordination information 432 may indicate the mode.

In some implementations, base station 105 includes at least one processor, such as processor 452, and a memory (e.g., 454) coupled to the at least one processor and storing instructions that, when executed by the at least one processor, is configure to cause the at least one processor to generate configuration information, such as cell selection configuration information 470, associated with a cell selection procedure for UE 115, the configuration information includes energy harvesting information, RS configuration information, or a combination thereof. The processor-readable instructions are further configured to cause the at least one processor to initiate transmission of the configuration information to the UE.

Another innovative aspect of the subject matter described in this disclosure may be implemented in UE 115. UE 115 includes at least one processor, such as processor 402, and a memory (e.g., 404) coupled with the at least one processor and storing processor-readable instructions that, when executed by the at least one processor, is configured to cause the at least one processor to receive, from base station 105, first configuration information, such as cell selection configuration information 470, associated with a cell selection procedure, the first configuration information includes energy harvesting information, RS configuration information, or a combination thereof. The processor-readable instructions are further configured to cause the at least one processor to perform the cell selection procedure based on the first configuration information.

As described with reference to FIG. 4, the present disclosure provides techniques for network-assisted cell selection for a device, such as UE 115. The network-assisted cell selection may enable improved communications, including reduced power consumption by the device, reduced overhead signaling, reduced interference, or a combination thereof.

FIG. 5 is a ladder diagram of an example of network-assisted cell selection for a device. As shown in FIG. 5, a corresponding system of the ladder diagram includes UE 115, base station 105, and base station 455. UE 115, base station 105, and base station 455 may include one or more components and be configured to perform one or more operations, as described with reference to FIGS. 1-4. Each of base station 105 and base station 455 may include or correspond to separate base stations or separate structures. For example, base station 105 may include or correspond to a first gNB or a first CU, and base station 455 may include or correspond to a second gNB or a second CU.

Referring to FIG. 5, during operation, at 502, base station 105 transmits a waveform to UE 115. In some implementations, the waveform at 502 may be a continuous waveform, may include one or more reference signals, or a combination thereof. The waveform may include or correspond to first reference signal 472. In some implementations, the waveform may also include or correspond to cell selection configuration information 470. Alternatively, in other implementations, base station 105 may transmit cell selection configuration information 470 to UE 115 prior or subsequent to transmission of the waveform at 502.

At 504, base station 455 transmits a waveform to UE 115. In some implementations, the waveform at 504 may be a continuous waveform, may include one or more reference signals, or a combination thereof. In some implementations, the waveform may also include or correspond to cell selection configuration information. Alternatively, in other implementations, base station 455 may transmit cell selection configuration information to UE 115 prior or subsequent to transmission of the waveform at 504.

At 506, UE 115 transmits a backscatter waveform to base station 105. The backscatter waveform may be based on or responsive to the waveform at 502. The backscatter waveform may include or correspond to first backscatter waveform 474. At 508, UE 115 transmits a backscatter waveform to base station 105. The backscatter waveform may be based on or responsive to the waveform at 504. Although the backscatter waveforms at 506 and 508 are shown as being transmitted at the same time, in other implementations, the backscatter waveforms may be transmitted at different times or transmission of the backscatter waveforms may partially overlap.

At 510, a responding monitoring window, such as a time window, occurs. The responding monitoring window may be configured based on cell selection configuration information transmitted from base station 105 or base station 455. Alternatively, the responding monitoring window, or one or more characteristics thereof, such as a start time, a duration, or an end time, may be predefined, such as based on a standard. During the responding monitoring window at 510, UE 115 may monitor for one or more waveforms or signals from base station 105, base station 455, or a combination thereof.

At 512, base station 105 transmits a waveform to UE 115. In some implementations, the waveform at 512 may be a continuous waveform, may include one or more reference signals, or a combination thereof. The waveform may include or correspond to first reference signal 472. In some implementations, the waveform may also include or correspond to cell selection configuration information 470. Alternatively, in other implementations, base station 105 may transmit cell selection configuration information 470 to UE 115 prior or subsequent to transmission of the waveform at 502 or the waveform at 512.

At 514, base station 455 transmits a waveform to UE 115. In some implementations, the waveform at 514 may be a continuous waveform, may include one or more reference signals, or a combination thereof. In some implementations, the waveform may also include or correspond to cell selection configuration information. Alternatively, in other implementations, base station 455 may transmit cell selection configuration information to UE 115 prior or subsequent to transmission of the waveform at 504 or the waveform at 514.

At 516, UE 115 transmits a backscatter waveform to base station 105. The backscatter waveform may be based on or responsive to the waveform at 512. The backscatter waveform may include or correspond to first backscatter waveform 474. At 518, UE 115 transmits a backscatter waveform to base station 105. The backscatter waveform may be based on or responsive to the waveform at 514. Although the backscatter waveforms at 516 and 518 are shown as being transmitted at the same time, in other implementations, the backscatter waveforms may be transmitted at different times or transmission of the backscatter waveforms may partially overlap.

At 520, a responding monitoring window, such as a time window, occurs. The responding monitoring window may be configured based on cell selection configuration information transmitted from base station 105 or base station 455. During the responding monitoring window at 520, UE 115 may monitor for one or more waveforms or signals from base station 105, base station 455, or a combination thereof.

At 522, base station 105 transmits a waveform to UE 115. In some implementations, the waveform at 522 may be a continuous waveform. Additionally, or alternatively, the waveform at 522 may include one or more reference signals, an ID of the UE 115, a PCI associated with base station 105, or a combination thereof. The PCI may include or correspond to PCI 477. The waveform may include or correspond to second reference signal 476. The waveform at 522 may indicate that base station 105 is available or willing to serve UE 115. In some implementations, the waveform may also include or correspond to cell selection configuration information 470. Alternatively, in other implementations, base station 105 may transmit cell selection configuration information 470 to UE 115 prior or subsequent to transmission of the waveform at 502, the waveform at 512, or the waveform at 522.

At 524, base station 455 transmits a waveform to UE 115. In some implementations, the waveform at 524 may be a continuous waveform. Additionally, or alternatively, the waveform at 524 may include one or more reference signals, an ID of the UE 115, a PCI associated with base station 455, or a combination thereof. The waveform at 524 may indicate that base station 105 is available or willing to serve UE 115. In some implementations, the waveform may also include or correspond to cell selection configuration information. Alternatively, in other implementations, base station 455 may transmit cell selection configuration information to UE 115 prior or subsequent to transmission of the waveform at 504, the waveform at 514, or the waveform at 524.

At 526, UE 115 transmits a backscatter waveform to base station 105. The backscatter waveform may be based on or responsive to the waveform at 522. The backscatter waveform at 526 may include or correspond to second backscatter waveform 478. The back scatter waveform at 526 may include the PCI of the base station 526. In some implementations, the backscatter waveform at 526 may indicate whether or not UE 115 selects or requests base station 105 to be a serving cell for UE 115. It is noted that UE 115 received both the waveform at 522 and the waveform at 524. Accordingly, both the base station 105 and the base station 455 provided an indication of being available or willing to serve UE 115. UE 115 may select one of base station 105 or base station 455 randomly, based on configuration information received from base station 105, based on configuration information received from base station 455, based on a first received cell serve indication between the waveform at 522 and the waveform at 524, based on a characteristic of the waveform at 512, based on a characteristic of the waveform at 514, based on a characteristic of the waveform at 522, based on a characteristic of the waveform at 524, or a combination thereof. Although the backscatter waveform at 526 is shown as being transmitted after the responding monitoring window at 520, in other implementations, UE 115 may transmit the backscatter waveform at 526 during the responding monitoring window at 520.

In some implementations, base station 455 may detect the backscatter waveform at 526 and determine that UE 115 selects or requests base station 105 to be a serving cell for UE 115. For example, base station 455 may determine that the PCI included in or indicated by the backscatter waveform at 526 is the PCI of base station 105 and not the PIC of base station 455. Additionally, it is noted that UE 115 does not transmit a backscatter waveform or other signal to UE 415 to indicate that UE 115 does not select or request base station 455 to be a serving cell for UE 115. In some other implementations, UE 115 may transmit a backscatter waveform (responsive to the waveform at 524) or other signal to UE 415 to indicate that UE 115 does not select or request base station 455 to be a serving cell for UE 115.

FIGS. 6 and 7 are each a ladder diagram of an example of network-assisted cell selection for a device. As shown in FIGS. 6 and 7, a corresponding system of the ladder diagram includes UE 115, base station 105, UE 415, and base station 455. UE 115, base station 105, UE 415, and base station 455 may include one or more components and be configured to perform one or more operations, as described with reference to FIGS. 1-4. Each of base station 105 and base station 455 may include or correspond to separate base stations or separate structures. For example, base station 105 may include or correspond to a first gNB or a first CU, and base station 455 may include or correspond to a second gNB or a second CU.

Referring to FIG. 6, during operation, at 602, base station 105 transmits a waveform to UE 115. In some implementations, the waveform at 602 may be a continuous waveform, may include one or more reference signals, or a combination thereof. The waveform may include or correspond to first reference signal 472. In some implementations, the waveform may also include or correspond to cell selection configuration information 470. Alternatively, in other implementations, base station 105 may transmit cell selection configuration information 470 to UE 115 prior or subsequent to transmission of the waveform at 602.

At 604, base station 105 transmits a waveform to UE 415. In some implementations, the waveform at 604 may be a continuous waveform, may include one or more reference signals, or a combination thereof. The waveform may include or correspond to first reference signal 472. In some implementations, the waveform may also include or correspond to cell selection configuration information 470. Alternatively, in other implementations, base station 105 may transmit cell selection configuration information 470 to UE 415 prior or subsequent to transmission of the waveform at 604.

The waveform at 602 and the waveform at 604 may be the same waveform. For example, base station 105 may broadcast the waveform to UE 115 and UE 415.

At 606, base station 455 transmits a waveform to UE 115. In some implementations, the waveform at 606 may be a continuous waveform, may include one or more reference signals, or a combination thereof. In some implementations, the waveform may also include or correspond to cell selection configuration information. Alternatively, in other implementations, base station 455 may transmit cell selection configuration information to UE 115 prior or subsequent to transmission of the waveform at 606.

At 608, base station 455 transmits a waveform to UE 415. In some implementations, the waveform at 608 may be a continuous waveform, may include one or more reference signals, or a combination thereof. In some implementations, the waveform may also include or correspond to cell selection configuration information. Alternatively, in other implementations, base station 455 may transmit cell selection configuration information to UE 415 prior or subsequent to transmission of the waveform at 608.

The waveform at 606 and the waveform at 608 may be the same waveform. For example, base station 455 may broadcast the waveform to UE 115 and UE 415.

At 610, UE 115 transmits a backscatter waveform to base station 105. The backscatter waveform may be based on or responsive to the waveform at 602. The backscatter waveform may include or correspond to first backscatter waveform 474. At 612, UE 115 transmits a backscatter waveform to base station 455. The backscatter waveform may be based on or responsive to the waveform at 606. Although the backscatter waveforms at 610 and 612 are shown as being transmitted at the same time, in other implementations, the backscatter waveforms may be transmitted at different times or transmission of the backscatter waveforms may partially overlap.

At 614, UE 115 transmits a backscatter waveform to base station 105. The backscatter waveform at 614 may be based on or responsive to the waveform at 604. At 616, UE 115 transmits a backscatter waveform to base station 455. The backscatter waveform at 616 may be based on or responsive to the waveform at 608. Although the backscatter waveforms at 614 and 616 are shown as being transmitted at the same time, in other implementations, the backscatter waveforms may be transmitted at different times or transmission of the backscatter waveforms may partially overlap.

At 618, base station 105 and base station 455 exchange UE measurement information. For example, base station 105 may measure one or more characteristics of the backscatter waveform at 610, one or more characteristics of the backscatter waveform 614, or a combination thereof. As another example, base station 455 may measure one or more characteristics of the backscatter waveform at 612, one or more characteristics of the backscatter waveform 616, or a combination thereof. The UE measurement information exchanged between base station 105 and base station 455 may include one or more characteristics of the backscatter waveform at 610, one or more characteristics of the backscatter waveform 614, one or more characteristics of the backscatter waveform at 612, one or more characteristics of the backscatter waveform 616, the ID of UE 115, the ID of UE 415, or a combination thereof. Although shown as a single exchange of UE measurement information, in other implementations, base station 105 and base station 455 may exchange UE measurement information multiple times.

At 620, a responding monitoring window, such as a time window, occurs. The responding monitoring window may be configured based on cell selection configuration information transmitted from base station 105 or base station 455. During the responding monitoring window at 620, UE 115, UE 415, or both, may monitor for one or more waveforms or signals from base station 105, base station 455, or a combination thereof. As shown in FIG. 6, UE 115 and UE 415 have the same responding monitoring window. UE 115 and UE 415 having the same responding monitoring window may be based on or attributed to coordination between base station 105 and base station 455. For example, base station 105 and base station 455 may coordinate the responding monitoring window or receive an indication of the responding monitoring window from a core network (e.g., 130) or a CU (e.g., 310). Base station 105, base station 455, or both may communicate one or more parameters of the responding monitoring window to UE 115, UE 415, or both. In some implementations, the one or more parameters of the responding monitoring window may be included in or indicated by cell selection configuration information, such as cell selection configuration information 470.

At 622, base station 105 transmits a waveform to UE 115. In some implementations, the waveform at 622 may be a continuous waveform. Additionally, or alternatively, the waveform at 622 may include one or more reference signals, the ID of the UE 115, a PCI associated with base station 105, or a combination thereof. The PCI may include or correspond to PCI 477. The waveform may include or correspond to second reference signal 476. The waveform at 622 may indicate that base station 105 is available or willing to serve UE 115. In some implementations, the waveform may also include or correspond to cell selection configuration information 470. Alternatively, in other implementations, base station 105 may transmit cell selection configuration information 470 to UE 115 prior or subsequent to transmission of the waveform at 602 or the waveform at 622.

In some implementations, UE 115 transmits a backscatter waveform to base station 105. The backscatter waveform may be based on or responsive to the waveform at 622. The backscatter waveform may include or correspond to second backscatter waveform 478. The back scatter waveform may include the PCI of the base station 105. In some implementations, the backscatter waveform may indicate whether or not UE 115 selects or requests base station 105 to be a serving cell for UE 115.

At 624, base station 455 transmits a waveform to UE 415. In some implementations, the waveform at 624 may be a continuous waveform. Additionally, or alternatively, the waveform at 624 may include one or more reference signals, an ID of the UE 415, a PCI associated with base station 455, or a combination thereof. The waveform at 624 may indicate that base station 455 is available or willing to serve UE 415. In some implementations, the waveform may also include or correspond to cell selection configuration information. Alternatively, in other implementations, base station 455 may transmit cell selection configuration information to UE 415 prior or subsequent to transmission of the waveform at 608 or the waveform at 624.

In some implementations, UE 415 transmits a backscatter waveform to base station 455. The backscatter waveform may be based on or responsive to the waveform at 624. The back scatter waveform may include the PCI of the base station 455. In some implementations, the backscatter waveform may indicate whether or not UE 415 selects or requests base station 455 to be a serving cell for UE 415.

Referring to FIG. 7, one or more operations are performed as described with reference to FIG. 6. As compared to FIG. 6, UE 115 and UE 415 have different responding monitoring windows. UE 115 and UE 415 having the different responding monitoring windows may be based on or attributed to coordination between base station 105 and base station 455. For example, base station 105 and base station 455 may coordinate the responding monitoring window or receive an indication of the responding monitoring window from a core network (e.g., 130) or a CU (e.g., 310). Base station 105, base station 455, or both may communicate one or more parameters of the different responding monitoring windows to UE 115, UE 415, or both. In some implementations, the one or more parameters of the responding monitoring window may be included in or indicated by cell selection configuration information, such as cell selection configuration information 470.

In FIG. 7, during operation, the waveforms at 602, 604, 606, and 608 and the backscatter waveforms 610 and 612 are transmitted as described with reference to FIG. 6. At 720, a responding monitoring window associated with UE 115, such as a time window, occurs. The responding monitoring window associated with UE 115 may be configured based on cell selection configuration information transmitted from base station 105 or base station 455. During the responding monitoring window at 720, UE 115 may monitor for one or more waveforms or signals from base station 105, base station 455, or a combination thereof.

At 722, base station 105 and base station 455 exchange UE measurement information. For example, base station 105 may measure one or more characteristics of the backscatter waveform at 610. As another example, base station 455 may measure one or more characteristics of the backscatter waveform at 612. The UE measurement information exchanged between base station 105 and base station 455 may include one or more characteristics of the backscatter waveform at 610, one or more characteristics of the backscatter waveform at 612, the ID of UE 115, the ID of UE 415, or a combination thereof. Although shown as a single exchange of UE measurement information, in other implementations, base station 105 and base station 455 may exchange UE measurement information in multiple exchanges.

After the UE measurement information exchange at 722, the backscatter waveforms 614 and 616 are transmitted as described with reference to FIG. 6. At 721, a responding monitoring window associated with UE 415, such as a time window, occurs. The responding monitoring window associated with UE 415 may be configured based on cell selection configuration information transmitted from base station 105 or base station 455. During the responding monitoring window at 721, UE 415 may monitor for one or more waveforms or signals from base station 105, base station 455, or a combination thereof.

At 724, base station 105 and base station 455 exchange UE measurement information. For example, base station 105 may measure one or more characteristics of the backscatter waveform at 614. As another example, base station 455 may measure one or more characteristics of the backscatter waveform at 616. The UE measurement information exchanged between base station 105 and base station 455 may include one or more characteristics of the backscatter waveform at 614, one or more characteristics of the backscatter waveform at 616, the ID of UE 115, the ID of UE 415, or a combination thereof. Although shown as a single exchange of UE measurement information, in other implementations, base station 105 and base station 455 may exchange UE measurement information in multiple exchanges.

After the UE measurement information exchange at 724, base station 105 may transmit the waveform at 622 and base station 455 may transmit the waveform at 624 as described with reference to FIG. 6. Although the waveform at 622 and the waveform at 624 are described as being transmitted after the UE measurement information exchange at 724, in other implementations, the waveform at 622 or the waveform at 624 may be transmitted at a different time. For example, the waveform at 622 may be transmitted before the UE measurement information exchange at 724, the backscatter waveform at 614, the backscatter waveform at 616, or the UE measurement information exchange at 722. As another example, the waveform at 624 may be transmitted before the UE measurement information exchange at 724.

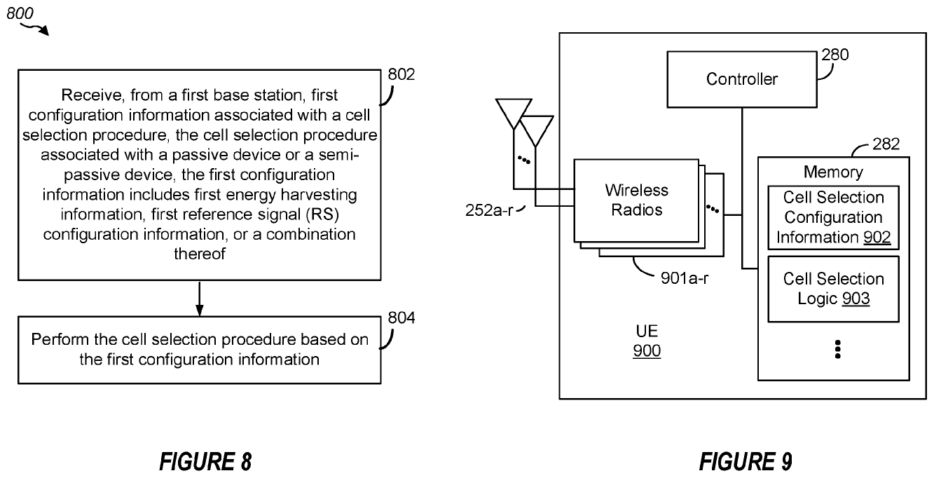

FIG. 8 is a flow diagram illustrating an example process 800 that supports network-assisted cell selection for a device according to one or more aspects. Operations of process 800 may be performed by a UE, such as UE 115 described above with reference to FIGS. 1-7 or a UE described with reference to FIG. 9. For example, example operations (also referred to as “blocks”) of process 800 may enable UE 115 to support network-assisted cell selection for a device.

In block 802, the UE receiving, from a first base station, first configuration information associated with a cell selection procedure. The cell selection procedure is associated with a passive device or a semi-passive device. The first base station may include or correspond to base station 105. The first configuration information may include or correspond to cell selection configuration information 460 or cell selection configuration information 470. The first configuration information may include or indicate first energy harvesting information, first RS configuration information, or a combination thereof. The energy harvesting information may include or indicate whether the base station supports energy harvesting. The first RS configuration information may include or indicate a periodicity of a cell selection reference signal, a number of backscatter reference signals, a time window parameter, or a combination thereof. In some implementations, the number of backscatter reference signals may be associated with or indicate a minimum number of backscatter reference signals. The time window parameter may include or indicate a time window start time, a time window duration, a time window end time, an offset value associated with a start of the time window or an end of the time window, or a combination thereof. In some implementations, the first configuration may include a UE identifier of the UE, a PCI associated with the first base station, a repetition indicator, a beam configuration, or a combination thereof. In some implementations, the UE determines, based on the first configuration information, whether the first base station supports energy harvesting, the periodicity of the cell selection reference signal, the number of backscatter reference signals, the time window parameter, the PCI associated with the first base station, the repetition indicator, the beam configuration, or a combination thereof.

In block 804, the UE performs the cell selection procedure based on the first configuration information. The cell selection procedure may include one or more operations associated with the UE selecting, or determining not to select, a cell. The cell selection procedure may enable the UE to register with a base station. In some implementations, after selecting or registering with the base station, the UE may include a PCI of the base station in one or more communications, such as messages or signals, transmitted by the UE.

To perform the cell selection operation, the UE may monitor for one or more signals or waveforms, receive one or more signals or waveforms from the first base station, generate one or more backscatter signal or waveforms, transmit the one or more backscatter signals or waveforms, or a combination thereof. For example, the UE may receive, from the first base station, a first reference signal. The first reference signal may include or correspond to first reference signal 472, the waveform at 502, the waveform at 512, or the waveform at 602. The UE may generate a first backscatter waveform based on the first reference signal. The first backscatter waveform may include or correspond to first backscatter waveform 474, the backscatter waveform at 506, the backscatter waveform at 516, or the backscatter waveform at 610. In some implementations, the first backscatter waveform may include one or more backscattered reference signals. Additionally, or alternatively, the first backscatter waveform may include or indicate the UE ID of the UE. The UE may transmit the first backscatter waveform and monitoring for a second reference signal from the first base station during a first monitoring time window. The second reference signal may include or correspond to second reference signal 476, the waveform at 522, or the waveform at 622. The second reference signal, the first monitoring time window, or both, may be associated with the first base station indicating that the first base station is available or willing to serve the UE.

In some implementations, the UE may determine whether or not to drop the first reference signal prior to generation of the first backscatter waveform. For example, the UE may determine whether or not to drop the first reference signal based on a detected power condition at the UE, a measured characteristic of the first reference signal, or a combination thereof. The detected power condition or the measured characteristic may include or correspond to measurement information 406. To illustrate, the UE may detect a power condition, such as low power condition or a low voltage condition. For example, the UE may determine a power level or a voltage level and perform a comparison based on the determined power level or the determined voltage level and a threshold. The UE may determine whether not to drop the first reference signal based on the power condition. For example, the UE may drop the first reference signal based on a result of the comparison. In some implementations, the UE may drop the first reference signal based on the power level or the voltage level failing to satisfy the threshold. For example, the power level or the voltage level may fail to satisfy the threshold if the power level or the voltage level is less than or equal to the threshold. Regarding the measured characteristic of the first reference signal, the UE may measure an error rate, RSRP, RSSI, RSRQ, or a combination thereof. The UE may perform a comparison based on the measured characteristic and a threshold. The UE may determine whether not to drop the first reference signal based on the measured characteristic. For example, the UE may drop the first reference signal based on a result of the comparison. In some implementations, the UE may drop the first reference signal based on measured characteristic failing to satisfy the threshold. For example, the measured characteristic may fail to satisfy the threshold if the measured characteristic (e.g., the RSRP, the RSSI, or the RSRQ) is greater than or equal to the threshold. As another example, the measured characteristic may fail to satisfy the threshold if the measured characteristic (e.g., the error rate) is greater than or equal to the threshold.

In some implementations, the UE receives the second reference signal. The second reference signal may include a PCI associated with the first base station, a UE ID of the UE, a cell serve indication, or a combination thereof. The PCI associated with the first base station may include or correspond to PCI 477. The UE may generate a second backscatter waveform based on the second reference signal. The second backscatter waveform may include or correspond to second backscatter waveform 478 or the backscatter waveform at 526. The second backscatter waveform may include an indication of the PCI of the first base station, a cell service request, or a combination thereof. In some implementations, the UE transmits the second backscatter waveform. The second backscatter waveform may indicate whether or not the UE selects or requests the base station to be a serving cell. In some implementations, if the UE does not select the base station to be the serving cell, the UE may not generate or transmit the second backscatter signal.

In some implementations, the UE receives, from a second base station, second configuration information associated with the cell selection procedure, or another cell selection procedure. The second base station may include or correspond to base station 455. The second configuration information may include information as described with reference to the first configuration, but associated with or applicable to the second base station. For example, the second configuration information may include second energy harvesting information, second RS configuration information, or a combination thereof. The UE may perform the cell selection procedure (or the other cell selection procedure) based on the second configuration. To illustrate, to perform the cell selection procedure (or the other cell selection procedure), the UE may receive, from the second base station, a third reference signal. The third reference signal may include or correspond to the waveform at 504, the waveform at 514, or the waveform at 606. Additionally, or alternatively, the UE may generate a third backscatter waveform based on the third reference signal and transmit the third backscatter waveform. The third backscatter waveform may include or correspond to the backscatter waveform at 508, the backscatter waveform at 518, or the backscatter waveform at 612. The third backscatter waveform may include or indicate the UE ID of the UE. After transmission of the third backscatter waveform, the UE may monitor for a fourth reference signal from the second base station during a second monitoring time window. In some implementations, the UE receives the fourth reference signal. The fourth reference signal may include or correspond to the waveform at 524. The fourth reference signal may include a PCI associated with the second base station, the UE ID of the UE, a cell serve indication, or a combination thereof.

In some implementations, the UE receives the second reference signal including a first cell serve indication associated with the first base station and receives the fourth reference signal including a second cell serve indication associated with the second base station. The UE may select one (or neither) of the first base station or the second base station to be a serving cell. In some implementations, the one of the first base station or the second base station may be selected randomly, based on the first configuration information, based on the second configuration information, based on a first received cell serve indication, based on a first characteristic of the second reference signal, based on a second characteristic of the fourth reference signal, or a combination thereof. For example, the UE may select a base station that supports energy harvesting. In some implementations, if both the first base station and the second base station support energy harvesting, the UE may make the selection randomly or based on another criterion. Additionally, or alternatively, the UE may select the base station on which one of the first characteristic and the second characteristic has a lower error rate, a higher signal quality, etc.

FIG. 9 is a block diagram of an example UE 900 that supports network-assisted cell selection for a device to one or more aspects. UE 900 may be configured to perform one or more operations, such as described with reference to FIGS. 4-8. In some implementations, UE 900 includes the structure, hardware, and components shown and described with reference to UE 115 of FIGS. 1-4. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266. In some implementations, UE 900 may include additional or fewer components than shown in FIG. 900. Additionally, or alternatively, in some implementations, UE 900 may be a passive device or a semi-passive device. For example, UE 900 may be or may include an RFID device, such as an RFID tag.

As shown, memory 282 may include cell selection configuration information 902 and cell selection logic 903. Cell selection configuration information 902 may include or correspond to cell selection configuration information 470. Cell selection logic 903 may be configured to perform a cell selection procedure or one or more cell selection operations. UE 900 may receive signals from or transmit signals to one or more network entities, such as base station 105 of FIG. 1, 2, or 4, disaggregated base station 300, RU 340, or a base station as illustrated in FIG. 11.

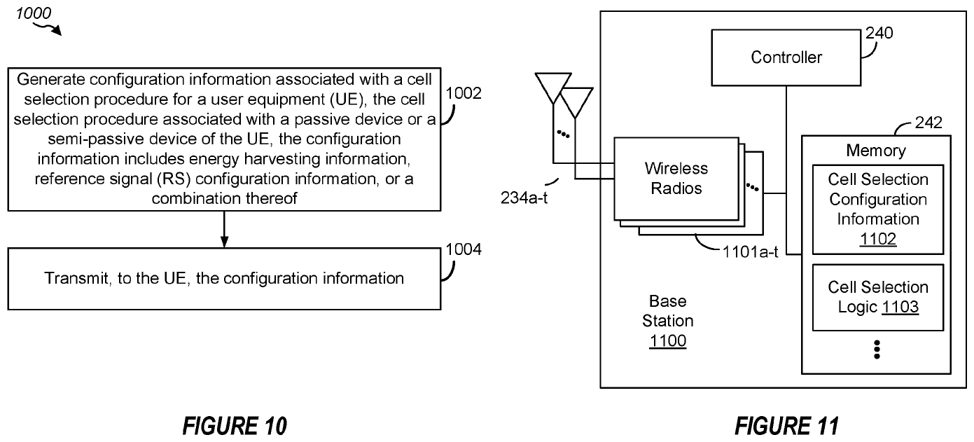

FIG. 10 is a flow diagram illustrating an example process 1000 that supports network-assisted cell selection for a device according to one or more aspects. Operations of process 1000 may be performed by a base station, such as base station 105 of FIG. 1, 2, or 4, disaggregated base station 300, RU 340, or a base station as illustrated in FIG. 11. For example, example operations of process 1000 may enable base station 105 to support network-assisted cell selection for a device.

At block 1002, the base station generates configuration information associated with a cell selection procedure for a UE. The UE may include or correspond to UE 115 or UE 415. In some implementations, the UE is or includes a passive device or a semi-passive device. The first configuration information may include or correspond to cell selection configuration information 460 or cell selection configuration information 470. The cell selection procedure is associated with a passive device or a semi-passive device. The configuration information includes energy harvesting information, RS configuration information, or a combination thereof. The energy harvesting information may indicate whether the base station supports energy harvesting. The RS configuration information may include or indicates a periodicity of a cell selection reference signal, a number of backscatter reference signals, a time window parameter, or a combination thereof. In some implementations, the number of backscatter reference signals may be associated with or indicate a minimum number of backscatter reference signals. The time window parameter may include or indicate a time window start time, a time window duration, a time window end time, an offset value associated with a start of the time window or an end of the time window, or a combination thereof. In some implementations, the configuration information may include a UE identifier of the UE, a PCI associated with the base station, a repetition indicator, a beam configuration, or a combination thereof. The PCI associated with the base station may include or correspond to PCI 477.

At block 1004, the base station transmits, to the UE, the configuration information. To illustrate, the base station may unicast, multicast, or broadcast the configuration information, as illustrative, non-limiting examples. In some implementations, the configuration information is TDM or FDM.

In some implementations, the base station transmits a first reference signal. The first reference signal may include or correspond to first reference signal 472, the waveform at 502, the waveform at 512, or the waveform at 602. The UE may transmit the first reference signal after transmission of the configuration information. In some implementations, the first reference signal may include the configuration information. Additionally, or alternatively, the first reference signal is TDM or FDM. The base station may transmit the first reference signal using beam-forming, pre-coding, or a combination thereof. The base station may transmit the first reference signal independent of or in coordination with another reference signal transmitted by another base station, such as base station 455.

In some implementations, the base station may receive, from the UE, a first backscatter waveform associated with the first reference signal. The first backscatter waveform may include or correspond to first backscatter waveform 474, the backscatter waveform at 506, the backscatter waveform at 516, or the backscatter waveform at 610. The base station may determine backscatter information based on the received first backscatter waveform. The backscatter information may be associated with a characteristic of the backscatter waveform. The backscatter information may include or correspond to measurement information 462.

In some implementations, after receiving the backscatter waveform, the base station receives a termination indication from the UE. Based on the received termination indication, the base station may discard the backscatter information associated with the backscatter waveform. Additionally, or alternatively, based on the received first backscatter waveform, the base station may transmit a second reference signal to the UE. the second reference signal includes a PCI associated with the base station, a UE ID of the UE, a cell serve indication, or a combination thereof. The second reference signal may include or correspond to second reference signal 476, the waveform at 522, or the waveform at 622. The second reference signal may be transmitted during a monitoring time window in which the UE monitors for the second reference signal. The second reference signal, the first monitoring time window, or both, may be associated with the first base station indicating whether or not the first base station is available or willing to serve the UE.

In some implementations, the base station may measure a characteristic associated with the first backscatter waveform. The measured characteristic may include or correspond to measurement information 462. The characteristic include may an error rate, an RSRP, an RSSI, an RSRQ, a number of backscatter reference signals associated with the backscatter waveform, or a combination thereof. The base station may perform a comparison based on a value of the measured characteristic and a threshold. The threshold may include or correspond to threshold 464. The second reference signal is transmitted based on a result of the comparison. For example, the base station may transmit the second reference signal based on measured characteristic satisfying the threshold. To illustrate, the measured characteristic may satisfy the threshold if the measured characteristic (e.g., the RSRP, the RSSI, or the RSRQ) is greater than or equal to the threshold. As another example, the measured characteristic may satisfy the threshold if the measured characteristic (e.g., the error rate or the number of backscatter reference signals associated with the first backscatter waveform) is less than or equal to the threshold. If the measured characteristic fails to satisfy the threshold, the base station may be unavailable or unwilling to serve the UE. If the base station is unavailable or unwilling to serve the UE, the base station may not send the second reference or the second reference signal may include a NACK. Alternatively, if the base station is available or willing to serve the UE, the base station may transmit the second reference signal. In some implementations, the base station is transmitted periodically.

In some implementations, after transmission of the second reference signal, such as when the base station is available or willing to serve the UE, the base station may monitor for a second backscatter waveform. The second backscatter waveform may include or correspond to second backscatter waveform 478 or the backscatter waveform at 526. The second backscatter waveform may include an indication of the PCI of the first base station, a cell service request, or a combination thereof.

In some implementations, the base station receives the second backscatter waveform associated with the second reference signal. The second backscatter waveform may include or correspond to second backscatter waveform 478 or the backscatter waveform at 526. The second backscatter waveform may include an indication of the PCI of the base station, a cell service request, or a combination thereof. The second backscatter waveform may indicate whether or not the UE selects or requests the base station to be a serving cell. The base station may determine whether the second backscatter waveform includes an indication of the PCI, a cell service request, or a combination thereof.

In some implementations, the base station may be configured to operate in a JCT mode, an NCJT, or a DPS mode to perform cell selection assistance operations. To illustrate, the base station may receive, from a network entity, a mode indication. The mode indication may be included in or indicated by a message, such as a message that includes coordination information 432. The network entity may include a core network, a CU, or another base station. The core network may include or correspond to core network 130. The CU may include or correspond to CU 310. If the base station receives the mode indication from the CU, the base station may include or correspond to DU 330 or RU 340, as non-illustrative examples.

In some implementations, the base station transmits a measurement report to a network entity. The measurement report may include or correspond to measurement information 462 or measurement information 480. The measurement report may include measurement information associated with the measured characteristic of the first backscatter waveform, a measured characteristic (e.g., an error rate, an RSRP, an RSSI, or an RSRQ,) of the second backscatter waveform, the UE ID, the PCI of the base station, or a combination thereof. The base station may receive, from the network entity, coordination information indicating one or more UEs to be served, a pre-coding, a beam configuration, a load, or a combination thereof. The coordination information may include or correspond to coordination information 432.

FIG. 11 is a block diagram of an example base station 1100 that supports network-assisted cell selection for a device according to one or more aspects. Base station 1100 may be configured to perform one or more operations, such as described with reference to FIGS. 4-7 or 10. In some implementations, base station 1100 includes the structure, hardware, and components shown and described with reference to base station 105 of FIGS. 1-4. For example, base station 1100 may include controller 240, which operates to execute logic or computer instructions stored in memory 242, as well as controlling the components of base station 1100 that provide the features and functionality of base station 1100. Base station 1100, under control of controller 240, transmits and receives signals via wireless radios 1101a-t and antennas 1134a-t. Wireless radios 1101a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include cell selection configuration information 1102 or cell selection logic 1103. Cell selection configuration information 1102 may include or correspond to cell selection configuration information 460 or cell selection configuration information 470. Cell selection logic 1103 may be configured to perform one or more cell selection operations, such as one or more cell selection assist operations associated with a cell selection operation or procedure performed by a UE, a passive device, a semi-passive device, or another device. Base station 1100 may receive signals from or transmit signals to one or more UEs, such as UE 115 of FIGS. 1-7 or UE 900 of FIG. 9.

It is noted that one or more blocks (or operations) described with reference to FIG. 5-8 or 10 may be combined with one or more blocks (or operations) described with reference to another of the figures. For example, one or more blocks (or operations) of FIG. 8 may be combined with one or more blocks (or operations) of FIG. 5, 6, or 7. As another example, one or more blocks associated with FIG. 10 may be combined with one or more blocks associated with FIG. 5, 6, or 7. As another example, one or more blocks associated with FIG. 8 or 10 may be combined with one or more blocks (or operations) associated with FIGS. 1-4. Additionally, or alternatively, one or more operations described above with reference to FIGS. 1-4 may be combined with one or more operations described with reference to FIG. 9 or 11.

In one or more aspects, techniques for supporting network-assisted cell selection for a device may include additional aspects, such as any single aspect or any combination of aspects described below or in connection with one or more other processes or devices described elsewhere herein. In a first aspect, techniques for supporting network-assisted cell selection for a device may include generating configuration information associated with a cell selection procedure for a UE. The cell selection procedure is associated with a passive device or a semi-passive device of the UE. The configuration information includes energy harvesting information, RS configuration information, or a combination thereof. The techniques may further include transmitting, to the UE, the configuration information. In some examples, the techniques in the first aspect may be implemented in a method or process. In some other examples, the techniques of the first aspect may be implemented in a wireless communication device such as a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the UE includes the passive device or the semi-passive device.

In a third aspect, in combination with one or more of the first aspect or the second aspect, the configuration information includes a UE identifier of the UE, a PCI associated with the base station, a repetition indicator, a beam configuration, or a combination thereof.

In a fourth aspect, in combination with one or more of the first aspect through the third aspect, the energy harvesting information is indicative of whether the base station supports energy harvesting.

In a fifth aspect, in combination with one or more of the first aspect through the fourth aspect, the RS configuration information is indicative of a periodicity of a cell selection reference signal, a number of backscatter reference signals, a time window parameter, or a combination thereof.

In a sixth aspect, in combination with one or more of the first aspect through the fifth aspect, the techniques further include transmitting a first reference signal.

In a seventh aspect, in combination with the sixth aspect, the techniques further include receiving, from the UE, a backscatter waveform associated with the first reference signal.

In an eighth aspect, in combination with the sixth aspect, the techniques further include determining backscatter information based on the received backscatter waveform, the backscatter information associated with a characteristic of the backscatter waveform.

In a ninth aspect, in combination with the eighth aspect, the techniques further include, after receiving the backscatter waveform, receiving a termination indication from the UE.

In a tenth aspect, in combination with the ninth aspect, the techniques further include discarding the backscatter information associated with the backscatter waveform. In some implementations, the information is discarded based on the termination indication.

In an eleventh aspect, in combination the sixth aspect, the techniques further include transmitting, based on the received backscatter waveform, a second reference signal to the UE, the second reference signal includes a PCI associated with the base station, a UE ID of the UE, a cell serve indication, or a combination thereof.

In a twelfth aspect, in combination with the eleventh aspect, the second reference signal or the configuration information is transmitted periodically, the configuration information includes the energy harvesting information and the RS confirmation information, or a combination thereof.

In a thirteenth aspect, in combination with the eleventh aspect, the techniques for transmitting the second reference signal includes transmitting a NACK.

In a fourteenth aspect, in combination with the eleventh aspect, the techniques further include, after transmission of the second reference signal, monitoring for a second backscatter waveform.

In a fifteenth aspect, in combination with the fourteenth aspect, the techniques further include receiving the second backscatter waveform associated with the second reference signal.

In a sixteenth aspect, in combination with the fifteenth aspect, the techniques further include determining whether the second backscatter waveform includes an indication of the PCI, a cell service request, or a combination thereof.

In a seventeenth aspect, in combination with the eleventh aspect, the techniques further include measuring a characteristic associated with the backscatter waveform, the characteristic includes an error rate, an RSRP, an RSSI, an RSRQ, a number of backscatter reference signals associated with the backscatter waveform, or a combination thereof.

In an eighteenth aspect, in combination with the seventeenth aspect, the techniques further include performing a comparison based on a value of the measured characteristic and a threshold.

In a nineteenth aspect, in combination with the eighteenth aspect, the second reference signal is transmitted based on a result of the comparison.

In a twentieth aspect, in combination with one or more of the seventeenth aspect through the nineteenth aspect, the techniques further include transmitting a measurement report to a network entity, the measurement report including measurement information associated with the measured characteristic, the UE ID, the PCI, or a combination thereof.

In a twenty-first aspect, in combination with the twentieth aspect, the techniques further include receiving, from the network entity, coordination information indicating one or more UEs to be served, a pre-coding, a beam configuration, a load, or a combination thereof.

In a twenty-second aspect, in combination with one or more of the first aspect through the twenty-first aspect, the techniques further include receiving, from a network entity, a mode indication.

In a twenty-third aspect, in combination with one or more of the first aspect through the twenty-second aspect, the mode indication is associated with a JCT mode, an NCJT, a DPS mode.

In one or more aspects, techniques for supporting network-assisted cell selection for a device may include additional aspects, such as any single aspect or any combination of aspects described below or in connection with one or more other processes or devices described elsewhere herein. In a twenty-fourth, techniques for supporting network-assisted cell selection for a device may include receiving, from a first base station, first configuration information associated with a cell selection procedure. The cell selection procedure associated with a passive device or a semi-passive device. The first configuration information includes first energy harvesting information, first reference signal (RS) configuration information, or a combination thereof. The techniques may further include performing the cell selection procedure based on the first configuration information. In some examples, the techniques in the twenty-fourth aspect may be implemented in a method or process. In some other examples, the techniques of the twenty-fourth aspect may be implemented in a wireless communication device such as a UE, a passive device, a semi-passive device, an RFID device, an RFID tag, or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a twenty-fifth aspect, in combination with the twenty-fourth aspect, the techniques further include determining, based on the first configuration information, whether the first base station supports energy harvesting, a periodicity of a cell selection reference signal, a number of backscatter reference signals, a time window parameter, a PCI associated with the first base station, a repetition indicator, a beam configuration, or a combination thereof.

In a twenty-sixth aspect, in combination with one or more of the twenty-fourth aspect or the twenty-fifth aspect, the techniques for performing the cell selection procedure further include receiving, from the first base station, a first reference signal.

In a twenty-seventh aspect, in combination with the twenty-sixth aspect, the techniques further include generating a first backscatter waveform based on the first reference signal.

In a twenty-eighth aspect, in combination with the twenty-seventh aspect, the techniques further include transmitting the first backscatter waveform.

In a twenty-ninth aspect, in combination with one or more of the twenty-fourth aspect through the twenty-eighth aspect, the techniques further include monitoring for a second reference signal from the first base station during a first monitoring time window.

In a thirtieth aspect, in combination with one or more of the twenty-sixth aspect through the twenty-ninth aspect, the techniques further include determining whether to drop the first reference signal prior to generating the first backscatter waveform based on the first reference signal. In some implementations, determining whether to drop the first reference signal is based on a detected power condition at the UE, a measured characteristic of the first reference signal, or a combination thereof.

In a thirty-first aspect, in combination with one or more of the twenty-sixth aspect through the thirtieth aspect, the techniques further include receiving the second reference signal, the second reference signal includes a PCI associated with the first base station, a UE ID of the UE, a cell serve indication, or a combination thereof.

In a thirty-second aspect, in combination with the thirty-first aspect, the techniques further include generating a second backscatter waveform based on the second reference signal, the second backscatter waveform including an indication of the PCI of the first base station, a cell service request, or a combination thereof.

In a thirty-third aspect, in combination with one or more of the thirty-second aspect, the techniques further include transmitting the second backscatter waveform.

In a thirty-fourth aspect, in combination with one or more of the twenty-fourth aspect through the thirty-fourth aspect, the techniques further include receiving, from a second base station, second configuration information associated with the cell selection procedure. In some implementations, the second configuration information includes second energy harvesting information, second RS configuration information, or a combination thereof.

In a thirty-fifth aspect, in combination with the thirty-third aspect, the techniques further include performing the cell selection procedure based on the second configuration information.

In a thirty-sixth aspect, in combination with the thirty-fifth aspect, the techniques for performing the cell selection procedure further include receiving, from the second base station, a third reference signal.

In a thirty-seventh aspect, in combination with the thirty-sixth aspect, the techniques for performing the cell selection procedure further include generating a third backscatter waveform based on the third reference signal.

In a thirty-eighth aspect, in combination with the thirty-seventh aspect, the techniques for performing the cell selection procedure further include transmitting the third backscatter waveform.

In a thirty-ninth aspect, in combination with the thirty-eighth aspect, the techniques for performing the cell selection procedure further include monitoring for a fourth reference signal from the second base station during a second monitoring time window.

In a fortieth aspect, in combination with the thirty-ninth aspect, 26. The method of claim 25, further comprising the techniques further include receiving the second reference signal including a first cell serve indication associated with the first base station.

In a forty-first aspect, in combination with the fortieth aspect, the techniques further include receiving the fourth reference signal including a second cell serve indication associated with the second base station.

In a forty-second aspect, in combination with the forty-first aspect, the techniques further include selecting one of the first base station or the second base station, the one of the first base station or the second base station selected randomly, based on the first configuration information, based on the second configuration information, based on a first received cell serve indication, based on a first characteristic of the second reference signal, based on a second characteristic of the fourth reference signal, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a base station, the method comprising:
generating configuration information associated with a cell selection procedure for a user equipment (UE), the cell selection procedure associated with a passive device or a semi-passive device of the UE, the configuration information includes energy harvesting information, reference signal (RS) configuration information, or a combination thereof; and
transmitting, to the UE, the configuration information.

2. The method of claim 1, wherein:
the UE includes the passive device or the semi-passive device;
the configuration information includes a UE identifier of the UE, a physical cell ID (PCI) associated with the base station, a repetition indicator, a beam configuration, or a combination thereof;
the energy harvesting information indicates whether the base station supports energy harvesting;
the RS configuration information indicates a periodicity of a cell selection reference signal, a number of backscatter reference signals, a time window parameter, or a combination thereof; or
a combination thereof.

3. The method of claim 1, further comprising:
transmitting a first reference signal; and
receiving, from the UE, a backscatter waveform associated with the first reference signal.

4. The method of claim 3, further comprising:
determining backscatter information based on the received backscatter waveform, the backscatter information associated with a characteristic of the backscatter waveform;
after receiving the backscatter waveform, receiving a termination indication from the UE; and
discarding the backscatter information associated with the backscatter waveform.

5. The method of claim 3, further comprising:
transmitting, based on the received backscatter waveform, a second reference signal to the UE, the second reference signal includes a physical cell ID (PCI) associated with the base station, a UE ID of the UE, a cell serve indication, or a combination thereof.

6. The method of claim 5, wherein:
the second reference signal or the configuration information is transmitted periodically;
the configuration information includes the energy harvesting information and the RS configuration information; or
a combination thereof.

7. The method of claim 5, wherein transmitting the second reference signal includes transmitting a negative-acknowledgment (NACK).

8. The method of claim 5, further comprising:
after transmission of the second reference signal, monitoring for a second backscatter waveform;
receiving the second backscatter waveform associated with the second reference signal; and
determining whether the second backscatter waveform includes an indication of the PCI, a cell service request, or a combination thereof.

9. The method of claim 5, further comprising:
measuring a characteristic associated with the backscatter waveform, the characteristic includes an error rate, a reference signal received power (RSRP), a received signal strength indicator (RSSI), a reference signal received quality (RSRQ), a number of backscatter reference signals associated with the backscatter waveform, or a combination thereof.

10. The method of claim 9, further comprising:
performing a comparison based on a value of the measured characteristic and a threshold; and
wherein the second reference signal is transmitted based on a result of the comparison.

11. The method of claim 9, further comprising:
transmitting a measurement report to a network entity, the measurement report including measurement information associated with the measured characteristic, the UE ID, the PCI, or a combination thereof; and
receiving, from the network entity, coordination information indicating one or more UEs to be served, a pre-coding, a beam configuration, a load, or a combination thereof.

12. The method of claim 1, further comprising:
receiving, from a network entity, a mode indication, the mode indication associated with a joint coherent transmission (JCT) mode, a non-coherent joint transmission (NCJT), a dynamic point selection (DPS) mode.

13. A base station comprising:
a memory storing processor-readable code; and
at least one processor coupled to the memory, the at least one processor configured to execute the processor-readable code to cause the at least one processor to:
generate configuration information associated with a cell selection procedure for a user equipment (UE), the cell selection procedure associated with a passive device or a semi-passive device of the UE, the configuration information includes energy harvesting information, reference signal (RS) configuration information, or a combination thereof; and
initiate transmission of the configuration information to the UE.

14. The base station of claim 13, wherein the at least one processor is further configured to execute the processor-readable code to cause the at least one processor to:
initiate transmission of a first reference signal; and
receive, from the UE, a backscatter waveform associated with the first reference signal.

15. The base station of claim 14, wherein the at least one processor is further configured to execute the processor-readable code to cause the at least one processor to:
initiate transmission of, based on the received backscatter waveform, a second reference signal to the UE, the second reference signal includes a physical cell ID (PCI) associated with the base station, a UE ID of the UE, a cell serve indication, or a combination thereof.

16. The base station of claim 15, wherein the at least one processor is further configured to execute the processor-readable code to cause the at least one processor to:
after transmission of the second reference signal, monitor for a second backscatter waveform;
receive the second backscatter waveform associated with the second reference signal; and
determine whether the second backscatter waveform includes an indication of the PCI, a cell service request, or a combination thereof.

17. The base station of claim 15, wherein the at least one processor is further configured to execute the processor-readable code to cause the at least one processor to:
measure a characteristic associated with the backscatter waveform, the characteristic includes an error rate, a reference signal received power (RSRP), a received signal strength indicator (RSSI), a reference signal received quality (RSRQ), a number of backscatter reference signals associated with the backscatter waveform, or a combination thereof; and
perform a comparison based on a value of the measured characteristic and a threshold; and
wherein the second reference signal is transmitted based on a result of the comparison.

18. The base station of claim 15, wherein the at least one processor is further configured to execute the processor-readable code to cause the at least one processor to:
measure a characteristic associated with the backscatter waveform, the characteristic includes an error rate, a reference signal received power (RSRP), a received signal strength indicator (RSSI), a reference signal received quality (RSRQ), a number of backscatter reference signals associated with the backscatter waveform, or a combination thereof;
initiate transmission of a measurement report to a network entity, the measurement report including measurement information associated with the measured characteristic, the UE ID, the PCI, or a combination thereof; and
receive, from the network entity, coordination information indicating one or more UEs to be served, a pre-coding, a beam configuration, a load, or a combination thereof.

19. The base station of claim 13, wherein the at least one processor is further configured to execute the processor-readable code to cause the at least one processor to:
receive, from a network entity, a mode indication, the mode indication associated with a joint coherent transmission (JCT) mode, a non-coherent joint transmission (NCJT), a dynamic point selection (DPS) mode.

20. A method of wireless communication performed by a user equipment (UE), the method comprising:
receiving, from a first base station, first configuration information associated with a cell selection procedure, the cell selection procedure associated with a passive device or a semi-passive device, the first configuration information includes first energy harvesting information, first reference signal (RS) configuration information, or a combination thereof; and
performing the cell selection procedure based on the first configuration information.

21. The method of claim 20, further comprising:
determining, based on the first configuration information, whether the first base station supports energy harvesting, a periodicity of a cell selection reference signal, a number of backscatter reference signals, a time window parameter, a physical cell ID (PCI) associated with the first base station, a repetition indicator, a beam configuration, or a combination thereof.

22. The method of claim 20, wherein performing the cell selection procedure includes:
receiving, from the first base station, a first reference signal;
generating a first backscatter waveform based on the first reference signal;
transmitting the first backscatter waveform; and
monitoring for a second reference signal from the first base station during a first monitoring time window.

23. The method of claim 22, further comprising:
determining whether to drop the first reference signal prior to generating the first backscatter waveform based on the first reference signal, wherein determining whether to drop the first reference signal is based on a detected power condition at the UE, a measured characteristic of the first reference signal, or a combination thereof.

24. The method of claim 22, further comprising:
receiving the second reference signal, the second reference signal includes a physical cell ID (PCI) associated with the first base station, a UE ID of the UE, a cell serve indication, or a combination thereof;
generating a second backscatter waveform based on the second reference signal, the second backscatter waveform including an indication of the PCI of the first base station, a cell service request, or a combination thereof; and
transmitting the second backscatter waveform.

25. The method of claim 22, further comprising:
receiving, from a second base station, second configuration information associated with the cell selection procedure, the second configuration information includes second energy harvesting information, second RS configuration information, or a combination thereof; and
performing the cell selection procedure based on the second configuration information, wherein performing the cell selection procedure includes:
receiving, from the second base station, a third reference signal;
generating a third backscatter waveform based on the third reference signal;
transmitting the third backscatter waveform; and
monitoring for a fourth reference signal from the second base station during a second monitoring time window.

26. The method of claim 25, further comprising:
receiving the second reference signal including a first cell serve indication associated with the first base station;
receiving the fourth reference signal including a second cell serve indication associated with the second base station; and
selecting one of the first base station or the second base station, the one of the first base station or the second base station selected randomly, based on the first configuration information, based on the second configuration information, based on a first received cell serve indication, based on a first characteristic of the second reference signal, based on a second characteristic of the fourth reference signal, or a combination thereof.

27. A user equipment (UE) comprising:
a memory storing processor-readable code; and
at least one processor coupled to the memory, the at least one processor configured to execute the processor-readable code to cause the at least one processor to:
receive, from a first base station, first configuration information associated with a cell selection procedure, the cell selection procedure associated with a passive device or a semi-passive device, the first configuration information includes first energy harvesting information, first reference signal (RS) configuration information, or a combination thereof; and
perform the cell selection procedure based on the first configuration information.

28. The UE of claim 27, wherein, to perform the cell selection procedure, the at least one processor is further configured to execute the processor-readable code to cause the at least one processor to:
receive, from the first base station, a first reference signal;
determine whether to drop the first reference signal based on a detected power condition at the UE, a measured characteristic of the first reference signal, or a combination thereof;
generate a first backscatter waveform based on the first reference signal; and
initiate transmission of the first backscatter waveform; and
monitor for a second reference signal from the first base station during a first monitoring time window.

29. The UE of claim 28, wherein the at least one processor is further configured to execute the processor-readable code to cause the at least one processor to:
receive, from the first base station, a first reference signal;
generate a first backscatter waveform based on the first reference signal;
initiate transmission of the first backscatter waveform;
monitor for a second reference signal from the first base station during a first monitoring time window;
receive the second reference signal, the second reference signal includes a physical cell ID (PCI) associated with the first base station, a UE ID of the UE, a cell serve indication, or a combination thereof;
generate a second backscatter waveform based on the second reference signal, the second backscatter waveform including an indication of the PCI of the first base station, a cell service request, or a combination thereof; and
initiate transmission of the second backscatter waveform.

30. The UE of claim 29, wherein the at least one processor is further configured to execute the processor-readable code to cause the at least one processor to:
receive, from a second base station, second configuration information associated with the cell selection procedure, the second configuration information includes second energy harvesting information, second RS configuration information, or a combination thereof;
receive, from the second base station, a third reference signal;
generate a third backscatter waveform based on the third reference signal; and
initiate transmission of the third backscatter waveform;
monitor for a fourth reference signal from the second base station during a second monitoring time window;
receive the fourth reference signal including a second cell serve indication associated with the second base station; and
select of the first base station, the first base station selected randomly, based on the first configuration information, based on the second configuration information, based on a first received cell serve indication, based on a first characteristic of the second reference signal, based on a second characteristic of the fourth reference signal, or a combination thereof.
